(19) United States
(12) Patent Application Publication
(10) Pub. No.: US 2026/0276898 A1
(43) Pub. Date: Sep. 17, 2026

(54) INTEGRATED OPTICAL CIRCUIT HAVING SWITCH DEVICES ELECTRICALLY CONNECTED BY THROUGH-SUBSTRATE VIA

(71) Applicant: nEye Systems, Inc., Emeryville, CA (US)

(72) Inventors: Ming Chiang A. Wu, Piedmont, CA (US); Tae Joon Seok, El Cerrito, CA (US); Sergio Fabian Almeida Loya, Moraga, CA (US); Kyungmok Kwon, El Cerrito, CA (US)

(21) Appl. No.: 19/551,094

(22) Filed: Feb. 26, 2026

Related U.S. Application Data
(60) Provisional application No. 63/764,459, filed on Feb. 27, 2025.

(51) Int. Cl. G02B 6/35

(52) U.S. Cl. CPC G02B 6/3584; G02B 6/3504; G02B 6/3546

(57) ABSTRACT

The present disclosure is directed to integrated optical switch circuits and packages. An optical switch circuit includes a substrate having formed thereover a fixed waveguide layer comprising a first bus optical waveguide, a second bus optical waveguide and first bias electrode regions, a suspended waveguide layer formed over the fixed waveguide layer and comprising a first shunt optical waveguide and second bias electrode regions electrically isolated from the first bias electrode regions. The optical switch circuit includes a through-substrate via (TSV) formed through the substrate to electrically connect to the first bias electrode regions, where upon application of a voltage across the first and second bias electrode regions, at least one end region of the first shunt waveguide mechanically bends toward the first bus optical waveguide or the second bus optical waveguide, thereby redirecting light from the first bus optical waveguide to the second bus optical waveguide.

This application claims benefit under 35 U.S.C. § 119(e) of U.S. Provisional Patent Application No. 63/764459, entitled “SEALED INTEGRATED OPTICAL CIRCUIT SWITCH DEVICES WITH ELECTRICAL FEEDTHROUGH” filed on Feb. 27, 2025, which is incorporated herein by reference in their entirety.

### BACKGROUND

### Field of the Invention

The present disclosure generally relates to optical switches used for routing optical signals in photonic systems, and more particularly to arrays of electromechanically actuated optical switches enclosed in sealed packages.

### Description of the Related Art

Performing data processing and data transport tasks in an optical domain can significantly increase data transmission and processing rates compared to electronic systems. One of the important tasks in most computing or communication systems is controlling signal paths within a network of signal channels. A switching circuit can include reconfigurable interconnections that controllably transfer signals between different channels. Optical switching circuits that provide reconfigurable optical interconnections between a plurality of optical waveguides are important building blocks in most optical processing and communication systems and their performance advantages can have a significant impact on these systems.

### SUMMARY

In some aspects, the techniques described herein relate to an integrated optical circuit, including: a substrate having formed thereover a fixed waveguide layer including a first bus optical waveguide, a second bus optical waveguide and first bias electrode regions; a suspended waveguide layer formed over the fixed waveguide layer and including a first shunt optical waveguide and second bias electrode regions electrically isolated from the first bias electrode regions; and one or both of: a first through-substrate via (TSV) formed through the substrate to electrically connect to the first bias electrode regions, and a second TSV formed through the substrate to electrically connect to the second bias electrode regions, wherein upon application of a voltage across the first and second bias electrode regions, at least one end region of the first shunt waveguide mechanically bends toward the first bus optical waveguide or the second bus optical waveguide, thereby redirecting light from the first bus optical waveguide to the second bus optical waveguide.

In some aspects, the techniques described herein relate to an integrated optical circuit, including: a substrate; a fixed waveguide layer formed over the substrate and including: first doped regions and second doped regions electrically isolated from the second doped regions, and a first bus optical waveguide, a second bus optical waveguide and first bias electrode regions electrically connected to the first doped regions; and a suspended waveguide layer formed over the fixed waveguide layer and including a first shunt optical waveguide and second bias electrode regions electrically connected to the second doped regions, wherein upon application of a voltage across the first bias electrode regions and the second bias electrode regions through the first doped regions and the second doped regions, respectively, at least one region of the shunt waveguide mechanically bends toward the first bus optical waveguide or the second bus optical waveguide, thereby redirecting light from the first bus optical waveguide to the second bus optical waveguide.

In some aspects, the techniques described herein relate to an integrated optical switch matrix including: a plurality of switching cells at crossings between first bus optical waveguides and second bus optical waveguides formed over a substrate, wherein each of the switching cells includes a shunt optical waveguide having one or more regions configured to mechanically bend toward one or both of respective ones of the first bus optical waveguide and the second bus optical waveguide upon application of a voltage between first bias electrode regions and second bias electrode regions, thereby causing light from the respective one of the first bus optical waveguide to be redirected to the respective one of the second bus optical waveguide; and one or both of: a first through-substrate via (TSV) formed through the substrate to electrically connect to the first bias electrode regions, and a second TSV formed through the substrate to electrically connect to the second bias electrode regions.

In some aspects, the techniques described herein relate to an integrated optical switch matrix including: a plurality of switching cells at crossings between first bus optical waveguides and second bus optical waveguides formed over a substrate, wherein each of the switching cells includes a shunt optical waveguide having one or more coupling regions configured to mechanically bend toward one or both of respective ones of the first bus optical waveguide and the second bus optical waveguide upon application of a voltage between first bias electrode regions and second bias electrode regions, thereby causing light from the respective one of the first bus optical waveguide to be redirected to the respective one of the second bus optical waveguide; and a waveguide layer formed over the substrate having formed therein one or both of the first and second bus optical waveguides, the waveguide layer including: first doped regions and second doped regions electrically isolated from the first doped regions, and first bias electrode regions electrically connected to the first doped regions.

In some aspects, the techniques described herein relate to an integrated optical circuit, including: a substrate having formed thereover a first bus optical waveguide and a second bus optical waveguide; a shunt optical waveguide having one or more regions configured to mechanically bend toward one or both of the first bus optical waveguide and the second bus optical waveguide upon application of a voltage between first bias electrode regions and second bias electrode regions, thereby causing light from the first bus optical waveguide to be redirected to the second bus optical waveguide; and one or both of: a first through-substrate via (TSV) formed through the substrate to electrically connect to the first bias electrode regions, and a second TSV formed through the substrate to electrically connect to the second bias electrode regions.

In some aspects, the techniques described herein relate to an integrated optical circuit, including: a substrate having formed thereover a first bus optical waveguide and a second bus optical waveguide; a shunt optical waveguide having one or more regions configured to mechanically bend toward one or both of the first bus optical waveguide and the second bus optical waveguide upon application of a voltage between first bias electrode regions and second bias electrode regions, thereby causing light from the first bus optical waveguide to be redirected to the second bus optical waveguide; and a waveguide layer formed over the substrate having formed therein one or both of the first and second bus optical waveguides, the waveguide layer including one or both of: first doped regions electrically connected to the first bias electrode regions, and second doped regions electrically isolated from the first doped regions and electrically connected to the second bias electrode regions.

In some aspects, the techniques described herein relate to a method of fabricating an integrated optical circuit die, the method including: providing a substrate having a first major surface and an opposing second major surface; forming a fixed waveguide layer over the first major surface of the substrate, the fixed waveguide layer including first and second bus optical waveguides, first bias electrode regions and at least one dielectric region electrically isolating the first bias electrode region from another conductive region of the fixed waveguide layer; forming a sacrificial layer and a conductive post over the first waveguide layer; forming a suspended waveguide layer over the sacrificial layer, the suspended waveguide layer including a first shunt section, the first shunt section including a first shunt optical waveguide and second bias electrode regions; removing a portion of the sacrificial layer to release the first shunt section and to form an opening over the substrate; forming a first conductive through substrate via (TSV) electrically connected to the first bias electrode regions, the first TSV vertically extending through the substrate and having a first terminal end exposed at the second major surface to form a first conductive contact pad; and forming a second TSV electrically connected to the second bias electrode regions via the conductive post and a conductive region of the fixed waveguide layer, the second TSV vertically extending through the substrate and having a second terminal end exposed at the second major surface to form a second conductive contact pad; wherein the first and second TSVs are electrically isolated by the at least one dielectric region.

### BRIEF DESCRIPTION OF THE DRAWINGS

FIG. 1A schematically illustrates an optical switch network comprising a plurality of bus optical waveguides that are controllably interconnected using a plurality of microelectromechanical systems (MEMS) optical switches.

FIG. 1B is a perspective view of an example optical switch array die or package comprising the optical switch network shown in FIG. 1A. The optical switch array package comprises a plurality of conductive contact pads formed on a major surface of the package and configured to control the plurality of (MEMS) optical switches.

FIG. 2A schematically illustrates a side cross-sectional view an optical switch array package comprising optical MEMS switches formed over a substrate and electrical feedthroughs formed within the substrate and electrically connected to individual ones of the optical MEMS switches.

FIG. 2B schematically illustrates a side cross-sectional view of an assembly formed by electrically connecting the optical switch array die shown in FIG. 2A to an electronic substrate.

FIG. 3A schematically illustrates a side cross-sectional view an example implementation of the optical switch array package or die shown in FIG. 2A depicting two optical MEMS switches and electrical feedthroughs formed through a substrate and electrically connected to individual ones of the two optical MEMS switches.

FIG. 3B schematically illustrates a top cross-sectional view of the optical switch array package or die shown in FIG. 3A, across a fixed waveguide layer and near a waveguide crossing region below a shunt section of one of the optical MEMS switches.

FIG. 3C schematically illustrates a top cross-sectional view of a shunt section of one of the optical MEMS switches.

FIGS. 4A-4C schematically illustrate side cross-sectional views of representative intermediate structures at different stages in the fabrication process of the optical switch array package depicted in FIG. 3A.

FIGS. 4D-4E schematically illustrate side cross-sectional views of structures at two stages of separating the optical switch-array package shown in FIG. 4C from a wafer and forming an optical facet, by dicing or cleaving.

FIGS. 5A-5C schematically illustrate side cross-sectional views of representative intermediate structures at different stages in the fabrication process of an optical facet via etching and separating the optical switch-array package shown in FIG. 4C from a wafer, by dicing or cleaving.

FIG. 6 schematically illustrates a side cross-sectional view of another embodiment of the optical switch-array package shown in FIG. 4E comprising isolation trenches.

FIG. 7 schematically illustrates another side cross-sectional view of the optical switch-array package shown in FIG. 4E depicting a mechanical support and two conductive bridges electrically connecting different regions of on the fixed waveguide layer.

FIG. 8 schematically illustrates a top cross-sectional view of another integrated optical switch package near a MEMS optical switch.

FIG. 9A schematically illustrates a top view of an example MEMS optical switch in the MEMS optical switch array package shown in FIG. 3A depicting a waveguide crossing, a shunt section, and the mechanical structures supporting the shunt section.

FIGS. 9B-9C schematically illustrate side cross-sectional views of a portion of the MEMS optical switch in FIG. 9A in a cut plane (indicated by AA′ in FIG. 1A) when the optical switch is in the OFF state (FIG. 9B) and ON state (FIG. 9C).

FIGS. 10A-10B schematically illustrate two side cross-sectional views of the MEMS optical switch in FIG. 9A depicting the metallic control electrodes electrically connected to electrical feedthroughs formed within the substrate.

FIGS. 11A-11B schematically illustrate two side cross-sectional views of another embodiment of the MEMS optical switch shown in FIG. 9A, comprising doped control electrodes electrically connected to electrical feedthroughs formed within the substrate.

### DETAILED DESCRIPTION

Signal operation in the optical domain can significantly increase bandwidth and reduce loss in data processing and transport compared to operation in the electrical domain. As such, it can be advantageous for at least a portion of the data-processing and transport tasks required in an application to be performed optically. An important task in any computing or communication operation is the control of signal paths within a network of signal channels. In many applications, this task is executed by switching circuits comprising a plurality of reconfigurable interconnections among the signal channels.

Optical switch networks and circuits provide reconfigurable optical interconnections between multiple optical channels (e.g., optical waveguides) and can replace electrical switching circuits when data is processed or transported in the optical domain. Such optical switching modules may include a plurality of optically interconnected switching cells, each configured to control optical signal flow between at least two optical channels of the module. Optical switch networks and circuits typically exhibit much lower power consumption than their electrical counterparts. Additionally, optical switches can provide substantially lower insertion loss, improving overall system performance. However, cascaded optical switches within an optical switch network can introduce path-dependent variations in loss, potentially degrading system performance. Low-loss optical switches mitigate such variations and can also reduce overall system power consumption.

Some existing optical switch networks rely on switching technologies or architectures that introduce excessive optical insertion loss at the interface between optical waveguides or that are difficult or expensive to fabricate at scale. In addition, certain optical switching platforms may support optical signals only within a limited spectral region (e.g., near-infrared wavelengths), restricting their usefulness in broadband or multi-wavelength systems.

Optical MEMS switches and optical MEMS switch networks can address these and other limitations of existing technologies. MEMS-based optical switches utilize micro-electromechanical structures (e.g., beam deflectors, or actuated waveguide elements) to mechanically manipulate optical paths with low optical loss. Optical MEMS switches can provide very low insertion loss, high port counts, low crosstalk, and broad wavelength compatibility across wide portions of the optical spectrum. They also dissipate very low static power, since mechanical actuation typically consumes power only essentially during state transitions. These characteristics make optical MEMS switches and switch networks suitable for scalable, low-loss, reconfigurable optical interconnects and enable them to overcome the fabrication challenges and loss limitations associated with many existing optical switching technologies.

As the number of optical MEMS switches within a switch array increase, providing electrical connections to each individual MEMS element becomes increasingly challenging. In high-density switch arrays, the lateral traces used to route electrical signals increasingly extend across longer distances and around numerous neighboring devices, which can cause routing congestion, and potential interference between adjacent lines. These laterally extended traces not only consume valuable chip area but can also introduce significant resistance and capacitance, degrading actuation speed and signal integrity. Moreover, densely packed routing layers can complicate fabrication, reduce yield, and limit scalability. As a result, conventional lateral-trace approaches become impractical for very large switch arrays, motivating the need for alternative interconnect schemes that can efficiently deliver electrical signals without compromising density or performance.

This disclosure describes the structure, design, and fabrication method for optical MEMS switch arrays dies and packages comprising back-side through-substrate vias (TSVs, also described herein as part of electrical feedthroughs or electrical connections) that can greatly simplify interconnection compared to lateral routing on the device surface. Vertical electrical vias can route control signals (e.g., control voltages) directly upward through a substrate on or over which the MEMS optical switches are formed. By forming through-substrate vias (e.g., through silicon vias) and terminating them in backside conductive contact pads, each MEMS optical switch can be individually addressed through a short, vertical interconnect path with reduced parasitic resistance and capacitance. While advanced electronic integrated circuits such as CPUs, GPUs, and 3D memory stacks use through silicon vias (TSVs) and backside redistribution layers to provide dense, low-parasitic interconnects to thousands or millions of circuit nodes, integration of TSVs in optical MEMS switches pose unique integration challenges. As disclosed herein, a MEMS optical switch network die can be engineered so that each switch cell connects to a dedicated backside pad through its own TSV, creating an array of electrical contacts analogous to the pad arrays found on modern electronic chips. Such an Optical MEMS switch die could then be solder-bonded or flip-chip mounted onto an underlying electronic substrate-such as an interposer, carrier board, or integrated control IC, greatly simplifying system-level integration. This configuration reduces routing congestion, improves electrical performance, enhances scalability, and enables dense optical-electrical co-packaging architectures suitable for large, high-port-count optical switching systems. The disclosed MEMS optical switches dies and packages may be used in a variety of applications including, but not limited to, communication, data centers, high performance computing (HPC), and artificial intelligence (AI) and machine learning (ML) AI/ML systems, and other applications.

The disclosed optical switches and switching cells may be fabricated using CMOS-compatible fabrication technologies. As such, in some embodiments, these MEMS optical switches and MEMS optical switch packages can be built directly on a silicon chip by leveraging capabilities of CMOS foundries and, in some cases, at least partially co-fabricated with CMOS devices, and electronic circuits (e.g., a control circuit that controls the optical switches) on a common chip.

In some cases, a MEMS optical switch may be used to form an optical switching cell (also referred to as switching cell) and multiple switching cells may be optically connected to form a network of controllable optical interconnections between optical waveguides fabricated on a common chip or substrate. In some examples, the optical waveguides may form a matrix structure or arrangement comprising a first array of waveguides (e.g., horizontal waveguides) and a second array of waveguides (e.g., vertical waveguides) forming a matrix of waveguide crossings. In some cases, a waveguide crossing may comprise overlapping portions of a waveguide of the first array of waveguides and a waveguide of the second array of waveguides. In some cases, a waveguide crossing can be made reconfigurable using an optical switch. The reconfigurable waveguide crossing can controllably couple light propagating in one of the waveguides to the other of the waveguide of the waveguide crossing.

In some embodiments, the switching cell may comprise a reconfigurable optical waveguide crossing including a pair of fixed-position bus optical waveguides of an optical network and a MEMS optical switch comprising a movable optical waveguide portion (herein referred to as a shunt optical waveguide) that can be optically coupled with and decoupled from each of the bus optical waveguides of the pair of bus optical waveguides by controlled actuation (e.g., electromechanical actuation such electrostatic mechanical actuation). In some embodiments, the shunt waveguide may comprise a bent (e.g., L-shape) waveguide configured to couple light from a bus waveguide to another bus waveguide via two coupling regions of the shunt waveguide, when the MEMS optical switch is actuated and is in an ON state. Each coupling region can be close to an end of the shunt waveguide and can be configured to couple light from a bus waveguide to the shunt waveguide when the optical switch is the ON state.

Some examples of optical waveguide networks comprising switching cells having optical switches are discussed in U.S. Pat. No. 10,061,085 issued Aug. 28, 2018, which is hereby incorporated by reference herein in its entirety. It will be understood that, to the extent that any of the incorporated content may be interpreted to be contradictory to corresponding content of the present disclosure, the present disclosure shall control.

### MEMS-Based Optical Switch Network

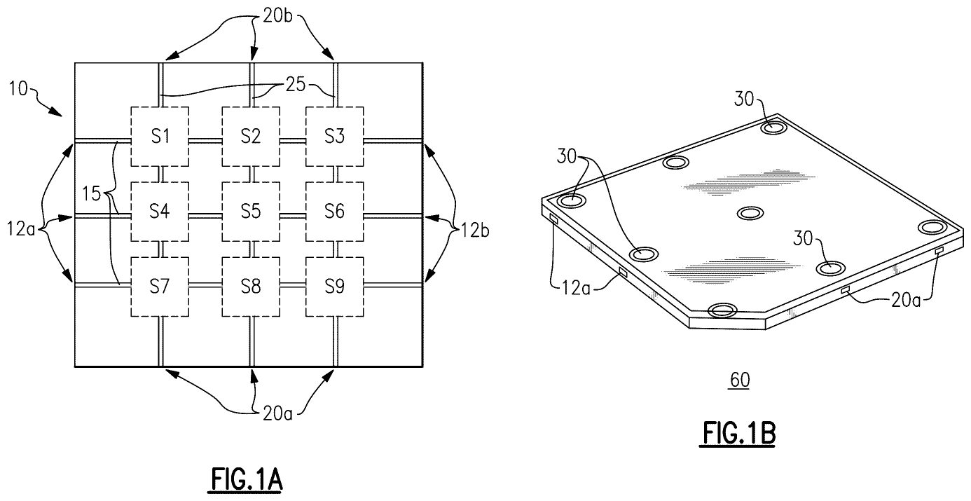

FIG. 1A schematically illustrates an example optical switch network 10 having a matrix architecture. The optical switch network 10 comprises a first plurality of optical waveguides 15 that are controllably interconnected to a second plurality of optical waveguides 25 using a matrix of switching cells (S1, S2, . . . S9). When all switching cells are in the OFF state, the first plurality of waveguides 15 optically connects a first plurality of optical ports 12a to a second plurality of optical ports 12b, and the second plurality of waveguides 25 optically connects a third of optical ports 20a to a fourth plurality of optical ports 20b.

In the example shown, for illustrative purposes, the first plurality of bus waveguides 15 includes three bus waveguides, the second plurality of bus waveguides 25 includes three bus waveguides, and the matrix of switching cells includes nine switching cells S1-S9. However, embodiments are not so limited and there may be more or less numbers of waveguides in the first waveguides 15 and second bus waveguides 25. In some examples, each switching cell provides controllable optical coupling between an individual bus waveguide of the first plurality of bus waveguides 15 and an individual bus waveguide of the second plurality of waveguides 25. In some examples, an individual switching cell can include at least one MEMS optical switch configured to optically couple one of the bus waveguides of the first plurality of waveguides 15 to one of the bus waveguides of the second plurality of waveguides 25. For example, when a switching cell is in the ON state, an optical signal received from one port of the first plurality of optical ports 12a, may be rerouted to one port of the third plurality of optical ports 20b or vice versa, by one optical switch of the switching cell. However, when in the ON state, the same MEMS optical switch may not reroute an optical signal received from one port of the second plurality of optical ports 12b, to one port of the third plurality of optical ports 20b or of the fourth plurality of optical ports 20a. In some embodiments, an individual switching cell may comprise two MEMS optical switches configured to switchably couple one bus waveguide of the first plurality of waveguides 15 to a bus waveguide of the second plurality of waveguides 25. In some such embodiments, when both optical switches of the switching cell are in the ON state, an optical signal received from one port of the first plurality of optical ports 12a, is rerouted to one port of the third plurality of optical ports 20b or vice versa, an optical signal received from one port of the second plurality of optical ports 12b is rerouted to one port of the third plurality of optical ports 20b (or vice versa) or to one port of the fourth plurality of optical ports 20a.

FIG. 1B schematically illustrates a perspective view of an example optical switch array die or package comprising the optical switch network shown in FIG. 1A. In some embodiments, the MEMS optical switch array die or package 60 may comprise a plurality of microelectromechanical systems (MEMS) optical switches integrated over a substrate. In some embodiments, the plurality of MEMS optical switches may be enclosed in a cavity (e.g., a sealed cavity) formed by the substrate and a capping layer. In some cases, the package (or enclosure) 60 may comprise electrical feedthroughs and optical waveguide facets that allow electrical and optical connections between the individual MEMS optical switches and external electronic and photonic circuits/devices, respectively. In some cases, the enclosure can be a sealed enclosed formed by attaching (e.g., bonding) a MEMS substrate comprising the MEMS optical switches and a capping layer configured to form a sealed cavity when attached to the MEMS substrate. In some cases, the enclosure may include two major surfaces (e.g., top and bottom major surfaces) and a plurality of sidewalls vertically extended between the two major surfaces. For example, a major surface can be a surface of the MEMS substrate, and another major surface can be a surface of the capping layer. In some embodiments, individual MEMS optical switches can be electrically connected to the conductive contact pads 30 (circular regions) formed on one of the major surfaces of the enclosure (e.g., a major surface of the MEMS substrate) and individual optical waveguides of the optical switch network 10 can be terminated at a facet and/or extended between two opposite facets of the enclosure (e.g., facets formed on the MEMS substrate). In some cases, a facet may comprise a sidewall of the package 60. In some cases, a facet of the enclosure (e.g., a facet formed on sidewall of the MEMS substrate) may comprise a plurality of optical ports (e.g., plurality of optical ports, 20b, 20a, 12a, or 12b). In some cases, the facet may be configured to allow low loss optical coupling between a bus waveguide of the MEMS optical switch array package 60 and an external optical waveguide (e.g., a fiber optical waveguide or an on-chip optical waveguide).

In some embodiments, at least some of the conductive pads 30 can be electrically isolated from the substrate on which they are formed and/or from each other to allow independent control of the individual MEMS optical switches enclosed within the package or die 60. In some embodiments, a conductive pad of the conductive pads 30 can be electrically connected to conductive region of an individual optical MEMS switch by a through-substrate vertical conductive via extending through the MEMS substrate. In some such embodiments, the conductive region may comprise an actuation electrode the MEMS optical switch or can be electrically connected to an actuation electrode the MEMS optical MEMS switch, in some cases, by a conductive bridge formed over the MEMS substrate. In some embodiments, a conductive pad of the conductive pads 30 may serve as a common conductive pad electrically connected to two actuation electrodes of two different MEMS optical switches. In some such embodiments, at least one of the two MEMS optical switches may be individually activated by applying a voltage between the common conductive pad and an electrically isolated conductive pad electrically connected to the other conductive electrode of the first MEMS optical switch.

To address various needs of integrated optical circuits described herein, according to various embodiments, an integrated optical circuit, e.g., an integrated optical switch package, comprises a first bus optical waveguide and a second bus optical waveguide a substrate having formed over a substrate. The integrated optical circuit additionally comprises a shunt optical waveguide having one or more regions configured to mechanically bend toward one or both of the first bus optical waveguide and the second bus optical waveguide upon application of a voltage between first bias electrode regions and second bias electrode regions, thereby causing light from the first bus optical waveguide to be redirected to the second bus optical waveguide. The integrated optical circuit additionally comprises one or both of: a first through-substrate via (TSV) formed through the substrate to electrically connect to the first bias electrode regions; and a second TSV formed through the substrate to electrically connect to the second bias electrode regions.

According to various other embodiments, an integrated optical circuit, e.g., an integrated optical switch package, comprises a first bus optical waveguide and a second bus optical waveguide a substrate having formed over a substrate. The integrated optical circuit additionally comprises a shunt optical waveguide having one or more regions configured to mechanically bend toward one or both of the first bus optical waveguide and the second bus optical waveguide upon application of a voltage between first bias electrode regions and second bias electrode regions, thereby causing light from the first bus optical waveguide to be redirected to the second bus optical waveguide. The integrated optical circuit additionally comprises a waveguide layer formed over the substrate having formed therein one or both of the first and second bus optical waveguides. The waveguide layer comprises one or both of first doped regions electrically connected to the first bias electrode regions and second doped regions electrically isolated from the second substrate regions and electrically connected to the second bias electrode regions. Various embodiments of these and other inventive aspects are described herein.

### Integrated Optical Switch Package

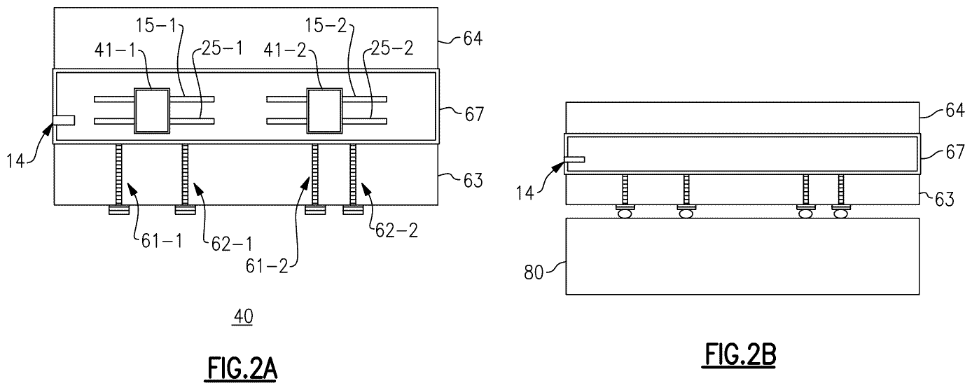

FIG. 2A schematically illustrates a side cross-sectional view an integrated optical switch package 40 comprising optical MEMS switches formed within optical switching layer 67 on or over a substrate, herein referred to as a base substrate 63, which may be a thinned semiconductor wafer such as thinned Si wafer, and through-substrate vias or electrical feedthroughs 61-1, 62-1, 62-2, and 61-2 formed within the base substrate 63 and electrically connected to the individual ones of a first MEMS optical switch 41-1 and a second MEMS optical switch 41-2. In some embodiments, the MEMS optical switch array package may comprise one or more features described above with respect to the MEMS optical switch array package 60. In some cases, the first MEMS optical switch 41-1 may be configured to optically couple a first bus waveguide 25-1 to a third bus waveguide 15-1 upon being actuated. In some cases, the second MEMS optical switch 41-2 may be configured to optically couple a fourth bus waveguide 15-2 to a second bus waveguide 25-2 upon being actuated. In some embodiments, the MEMS integrated optical switch package 40 may comprise an edge optical coupler 14 configured to optically couple one or more of the first, second, third, and fourth bus waveguides 25-1, 25-2, 15-1, and 15-2, to an external optical source and/or optical waveguide (e.g., via butt coupling or free-space coupling). In some embodiments, the optical switching layer 67 may comprise an opening within which the first and second MEMS optical switches 41-1, 41-2 are formed. In some such embodiments, the MEMS integrated optical switch package 40 may comprise a capping layer 64 attached (e.g., bonded) to the optical switching layer 67 over the opening to form cavity (e.g., a sealed cavity) containing the first and second MEMS optical switches 41-1, 41-2. In some embodiments the base substrate 63 may have a first major surface and an opposing second major surface, and the first and second MEMS optical switches 41-1, 41-2, may be disposed over the first surface of the base substrate 63. In some embodiments the first MEMS optical switch 41-1 may comprise a first shunt optical waveguide configured to be optically couple the first and third bus waveguides 25-1, 15-1, upon being actuated, and the second MEMS optical switch 41-2 may comprise a second shunt optical waveguide configured to be optically couple the second and fourth 25-2, 15-2, bus waveguides upon being actuated.

In some embodiments, the first MEMS optical switch is electrically connected to a first TSV or electrical feedthrough 61-1. In some cases, the first electrical feedthrough 61-1 may comprise a first conductive via, the first conductive via vertically extending through the base substrate 63 and having a first terminal end exposed at the second major surface of the base substrate 63 to form a first conductive contact pad. In some embodiments, the second MEMS optical switch is electrically connected to a second TSV or electrical feedthrough 61-2. In some cases, the second electrical feedthrough 61-2 may comprise a second conductive via, the second conductive via vertically extending through the base substrate 63 and having a second terminal end exposed at the second major surface of the base substrate 63 to form a second conductive contact pad. In some embodiments the first and second conductive electrical feedthroughs 61-1, 61-2, can be electrically isolated and can be configured to independently actuate the first and second shunt optical waveguides of the first and second MEMS optical switches 41-1, 41-2, respectively.

In some embodiments, the optical switching layer 67 may comprise a first waveguide layer, also referred to a fixed waveguide layer, formed on or over the base substrate 63. In some cases, the fixed waveguide comprises the first and third bus waveguides 25-1, 15-1. In some embodiments, the optical switching layer 67 may comprise a second waveguide layer, also referred to as a suspended waveguide layer, formed over the base substrate 63 and vertically separated from the fixed waveguide layer and comprising first and second shunt sections where the first and second shunt sections comprise the first and second shunt waveguides respectively. In some cases, the first shunt section may be configured to be electromechanically controlled via the first electrical feedthrough 61-1 and the second shunt section may be configured to be electromechanically controlled via the second electrical feedthrough 61-2. In some embodiments, the first MEMS optical switch 41-1 may be activated by applying a first activation voltage between the first and third conductive feedthroughs 61-1, 62-1, to optically couple the first and third bus waveguide 25-1, 15-1. In some embodiments, the second MEMS optical switch 41-2 may be activated, independent of the second MEMS optical switch 41-2 by applying a second activation voltage between the second and fourth conductive feedthroughs 61-2, 62-2, to optically couple the first and third bus waveguide 25-1, 15-1. In some embodiments, the third and fourth electrical feedthroughs 62-1, 62-2, can be electrically connected. In some such embodiments, the first and second activation voltages may be applied with reference to common potential (e.g., ground potential) applied to the electrical feedthroughs 62-1, 62-2. In some embodiments, the MEMS integrated optical switch package 40 may comprise a common electrical feedthrough electrically connected to both the first and second MEMS optical switches 41-1, 41-2. In some such embodiments, the first and second activation voltages may be applied with reference to common potential (e.g., ground potential) applied to the common electrical feedthrough.

In some cases, each one of the first, second, third, and fourth TSVs or electrical feedthroughs 61-1, 61-2, 61-3, 61-4, or a common feedthrough (not shown) can be vertically extended between a conductive region of the fixed waveguide layer and a conductive pad formed on or at the second major surface the base substrate 63.

In some embodiments, the fixed waveguide layer, within or on which bus waveguides are formed, may comprise two or more conductive regions electrically separated by insulating regions. In some examples, the conductive regions may comprise heavily doped semiconductor material, e.g., having a dopant concentration greater than about 1×10¹⁷ cm⁻³, and in some cases greater than about 1×10¹⁸ cm⁻³. In some examples, the conductive regions may comprise metallic regions (e.g., comprising, gold, copper, or a metallic alloy). In some examples, insulating regions may comprise intrinsic or lightly doped semiconductor material, e.g., having a dopant concentration less than about 1×10¹⁶ cm⁻³, and in some cases less than about 1×10¹⁷ cm⁻³. In some examples, the insulating regions may comprise a dielectric material (e.g., silicon nitride, silicon dioxide), or an air gap. In some examples, the insulating regions can be dielectric field trenches, or insulating regions formed by oxidation. In some embodiments, a conductive region of the fixed waveguide layer, formed over the base substrate 63, may serve as an actuation electrode (e.g., a bottom actuation electrode) of a MEMS optical switch formed within the structural MEMS layer 67.

In some embodiments, a conductive region in the fixed waveguide layer or a metallic pad formed on an insulating fixed waveguide layer may serve as a first actuation electrode (e.g., a bottom actuation electrode) of a MEMS optical switch formed within the structural MEMS layer 67. In some embodiments, a conductive region of the shunt section or a metallic pad formed on the shunt section may serve as a second actuation electrode (e.g., top actuation electrode) of the MEMS optical switch. In some cases, a conductive region serving as an actuation electrode, may be referred to as electrode region or bias electrode region.

In some embodiments, the first actuation electrode of the shunt section can be electrically connected to a conductive region of the fixed waveguide layer via a conductive post in the structural MEMS layer 67. In some cases, the conductive post can be a clamping structure configured to support the suspended waveguide layer over the fixed waveguide layer. In some embodiments, the conductive region may electrically connect the conductive post, and thereby the second actuation electrode, to an electrical feedthrough formed in the base layer 63. In some examples, the second electrical feedthrough 62-1 can be electrically connected to the first actuation electrode via a first conductive region of the fixed waveguide layer and the first electrical feedthrough 61-1 can be electrically connected to the second actuation electrode of the first shunt section through a conductive post and a second conductive region of the fixed waveguide layer.

In some embodiments, the conductive region of the first shunt section may comprise first and second conductive regions where the first shunt waveguide is laterally positioned between the first and second conductive regions of the first shunt section. In some cases, the first conductive region of the first shunt section may be electrically connected to the first electrical feedthrough 61-1 via conductive post extending between the base substrate 63 and the shun section. In some cases, the second conductive region of the first shunt section may be electrically connected to the first electrical feedthrough 61-1 via a conductive bridge (not shown) formed in the optical switching layer 67.

In some embodiments, the MEMS integrated optical switch package 40 may be bonded and electrically connected to an electrical substrate 80 via the conductive pads of the electrical feedthroughs 61-1, 62-1, 61-2, 62-2, to electrically connect individual MEMS optical switches of the package 40. In some cases, the electrical connection between the electrical substrate 80 and the MEMS integrated optical switch package 40 may comprise electrical paths established by solder bumps between the conductive pads of the electrical feedthroughs 61-1, 62-1, 61-2, 62-2, and the respective conductive pads of the electrical substrate 80. FIG. 2B schematically illustrates a side cross-sectional view of an assembly formed by electrically connecting the optical switch array die 40 to the electrical substrate 80. In some cases, the electrical substrate 80 may comprise an interposer. In some cases, the electrical substrate 80 may comprise an integrated electronic circuit (IC) such as a CMOS IC. In some examples, the electronic IC may comprise a control circuit configured to control the MEMS optical switches of the package 40 by controlling voltage provided to the electrical feedthroughs 61-1, 62-1, 61-2, 62-2.

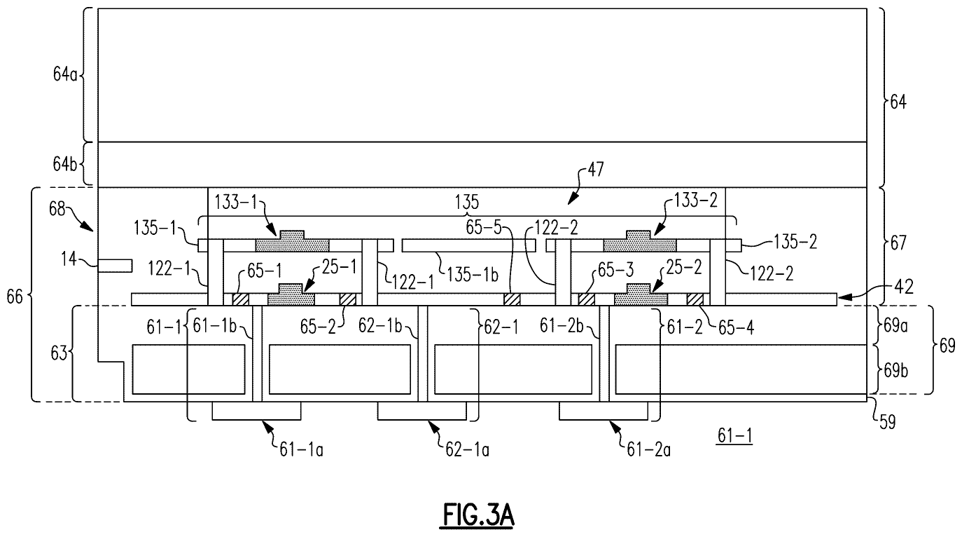

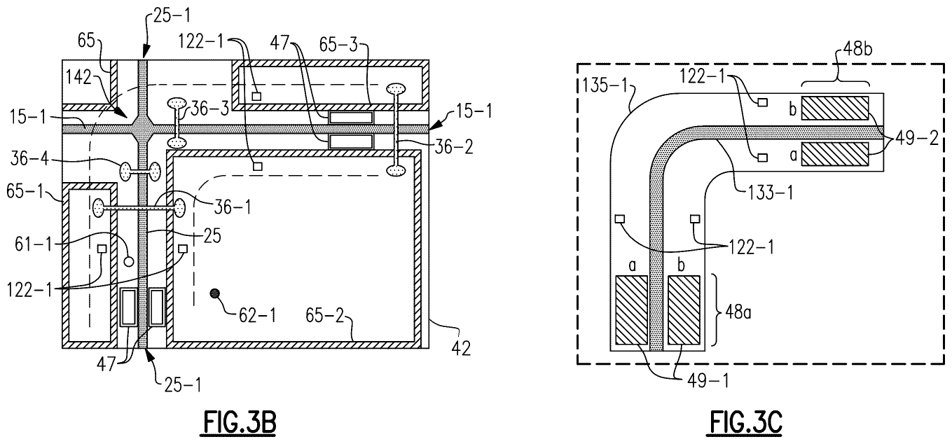

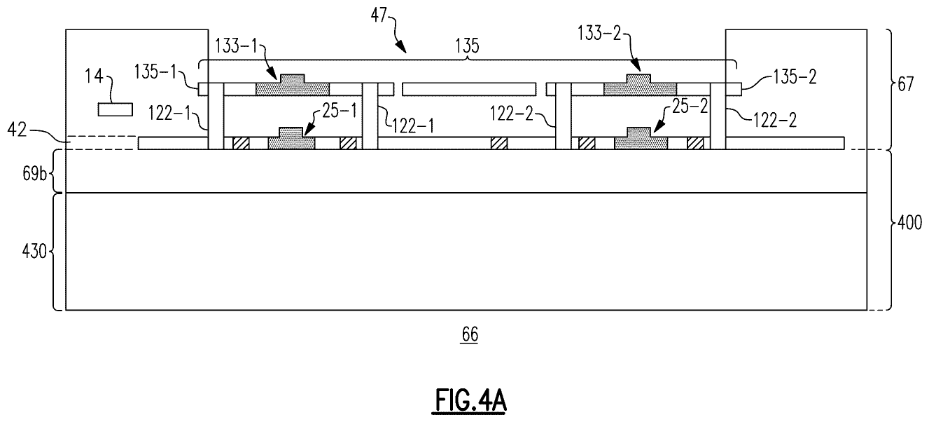

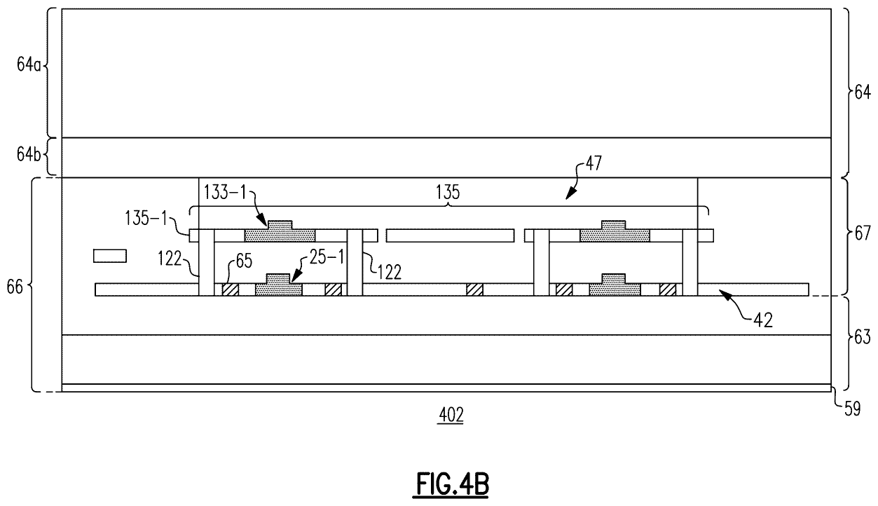

FIG. 3A schematically illustrates a side cross-sectional view an example implementation of the integrated optical switch package 40 shown in FIG. 2A depicting a portion of an integrated optical switch package 45 comprising two optical MEMS switches and TSVs or electrical feedthroughs formed through the base substrate 63 and electrically connected to electrode regions of the individual ones of the two optical MEMS switches. In some embodiments, integrated optical switch package 45 may include a MEMS substrate 66 comprising the bus optical waveguides and MEMS optical switches and a capping layer 64 to which the MEMS substrate 66 is bonded to form an enclosure comprising a sealed cavity 67 within which the MEMS optical switches are housed. (In some cases, the capping layer may comprise a capping substrate or a handle substrate. In some cases, the MEMS substrate 66 may comprise a base substrate 63 and a optical switching layer 67 formed on or over the base substrate 63. The MEMS. The capping layer 64 may comprise a single to multilayer substrate. In the example shown the capping layer 64 includes a first capping sublayer 64a and a second capping sublayer 64b where the second capping sublayer 64b is bonded or otherwise connected to the MEMS substrate 66. In some examples, the first capping sublayer 64 may comprise silicon and the second capping sublayer 64b may comprise silicon dioxide (SiO₂). However, the embodiments are not so limited and the capping layer 64 may include more or less than two sublayers. For example, in some embodiments, the capping layer 64 may comprise a single layer, e.g., a silicon substrate or a silicon wafer.

In some embodiments, the base substrate 63 may comprise a first base sublayer 69a, a second intermediate layer 69b, and lower insulating layer 59. In various embodiments, the fixed waveguide layer 42 may comprise a patterned silicon, polysilicon or amorphous silicon layer. However, embodiments are not so limited, and in some cases the fixed waveguide layer 42 may comprise patterned silicon nitride or a polymer material (e.g., PMMA, SU8, or the like). In some embodiments, the bus waveguides may be formed within and/or above the fixed waveguide layer 42. In some embodiments, the fixed waveguide layer or fixed waveguide layer 42 may comprise electrically conductive regions and insulating regions. In some cases, the electrically conductive regions may comprise highly doped semiconductor regions (e.g., highly doped silicon regions) and the semiconducting or insulating regions may comprise lightly doped or undoped semiconductor regions (lightly doped or intrinsic silicon regions). In some embodiments, the insulting regions may comprise oxide regions (e.g., silicon dioxide regions). In some embodiments, the first and second bus waveguides 25-1, 25-2 may comprise ridge or rib waveguides formed in insulating regions of the fixed waveguide layer 42. In various embodiments, first and second bus waveguides 25-1, 25-2, and other bus waveguide formed in the fixed waveguide layer 42 may comprise Si (e.g., monocrystalline or polycrystalline Si) or silicon nitride on insulator (e.g., SiO₂) waveguides, or polymer waveguides.

In some embodiments, optical switching layer 67 may comprise a suspended waveguide layer 135 vertically separated from the base substrate 63. In some embodiments, the suspended waveguide layer 135 may comprise shunt sections of the optical MEMS switches integrated in the optical switch package 45.

In some embodiments, each optical MEMS switch may comprise a shunt section comprising a shunt waveguide. The shunt section can be vertically separated from the fixed waveguide layer 42 by multiple posts or clamping support structures 122 and other mechanical support structures (not shown) fabricated on and/or over the base substrate 63. For example, the first MEMS optical switch may comprise a first shunt section 135-1 positioned over the first bus waveguide 25-1 and the second MEMS optical switch may comprise a second shunt section 135-2 positioned over the second bus waveguide 25-2. In some cases, the clamping support structures 122 may be configured to clamp a portion (e.g., a middle portion) of the first shunt section 135-1 to the base substrate 63 while allowing the two end regions of the first shunt section 135-1 to move in a vertical direction perpendicular to the top major surface of the base substrate 63. In some embodiments, each shunt section and the shunt waveguide therein may be configured to optically couple two bus waveguides, up on being activated.

FIG. 3B schematically illustrates a top cross-sectional view of the integrated optical switch package shown in FIG. 3A, across the fixed waveguide layer 42 and near an intersection of the first and third bus waveguides 25-1, 15-1 below a first shunt section 135-1 of the first optical MEMS switch. In some embodiments, the first bus waveguide 25-1 and the third bus waveguide 15-1 may extend within and/or on the fixed waveguide layer 42 along two crossing, e.g., substantially perpendicular, directions. In some cases, the intersection of the first and third bus waveguides 25-1, 15-1, herein referred to as crossing region 142, may be configured to reduce or potentially eliminate optical cross-talk between the first and third bus waveguides 25-1, 15-1. In some cases, the crossing region 142 may comprise a multi-mode interference region configured to prevent propagation of light between the first and the second waveguides at the crossing point, e.g., by concentrating the optical energy of the light signal near the center of the crossing region 142 as the light signal passes through it. In some of the embodiments, the first and third bus waveguides 25-1, 15-1, and the multi-mode interference region can be optically coupled via flared or tapered waveguide regions that mitigate optical loss associated with propagation from a bus waveguide to the crossing region and vice versa.

FIG. 3C schematically illustrates a top cross-sectional view of the first shunt section 135-1 of the first optical MEMS switch comprising a first shunt waveguide 133-1. In some embodiments, the first shunt waveguide 133-1 can be a bent optical waveguide portion extending from one end to another end of the shunt section 135. In some cases, the first shunt waveguide 133-1 can be a rib or ridge optical waveguide. In some cases, the first shunt section 135-1 can be a structure or a patterned layer fabricated above the bus waveguides 25-1, 15-1. In some cases, the first shunt section 135-1 may comprise a slab region and a ridge (or rib) region configured to confine light in a transverse direction perpendicular to the direction of propagation of light in the corresponding first shunt waveguide 133-1. In some cases, the first shunt section 135-1 can be a structure or a patterned layer fabricated above the bus waveguides 25-1, 15-1 and may comprise the first shunt waveguide 133-1 configured to guide light, and one or more electrodes (or conductive regions) configured to enable electromechanical actuation of the shunt section 135. In some cases, the first shunt section 135-1 may comprise a slab region and a ridge (or rib) region configured to confine light in a transverse direction perpendicular to the direction of propagation of light in the corresponding first shunt waveguide 133-1.

In some cases, the first shunt waveguide 133-1 may be aligned with the first and third bus waveguides 25-1, 15-1, such that the first shunt waveguide 133-1 can controllably shunt light from one of the first and third bus waveguides 25-1, 15-1, to the other to change the optical connection between the optical ports associated with these waveguides. For example, when the first shunt section 135-1 is in the OFF state, the first shunt waveguide 133-1 is optically decoupled from the first and third bus waveguides 25-1, 15-1 and light entering the third port 141a propagates to the fourth port 20b-1 via the crossing region 142. When the first shunt section 135-1 is in the ON state, the first shunt waveguide 133-1 is optically coupled to the first and third bus waveguides 25-1, 15-1 (e.g., using electromechanical actuation), and provides an optical path that bypasses the crossing region 142 and connects a portion of the first waveguide 25-1 to a portion of the third waveguide 15-1. In some cases, when the first shunt section 135-1 is actuated (is in ON state), end regions of the first shunt section 135-1 may bend vertically toward the fixed waveguide layer 42 to reduce vertical gaps between end regions of the first shunt waveguide 133-1 and the first and third bus waveguides 25-1, 15-1, thereby optically coupling one end region to the first bus waveguide 25-1 and the other end region to the third bus waveguide 15-1. In some cases, when actuated, the first shunt section 135-1 may redirect substantially the entire optical power propagating in the first bus waveguide 25-1 to the third bus waveguide 15-1 such that an amount of optical power that passes the crossing region 142 via the first waveguide 25-1 is negligible or substantially zero. For example, when it is in the ON state, the first shunt section 135-1 may redirect more than 90%, more than 95%, more than 97%, or more than 99% of the optical power propagating in the first bus waveguide 25-1 to the third bus waveguide 15-1.

In some embodiments, a shunt section can be electrostatically actuated by generating an electrical potential difference between a conductive region of the shunt section and an opposing conductive region below the shunt section, e.g., a conductive region formed within or over the fixed waveguide layer 42. In some embodiments, at least end regions 48a, 48b, of the shunt section may comprise conductive regions, herein referred to a shunt electrode regions or shunt bias electrode regions, and the fixed waveguide layer may comprise corresponding conductive regions below the shunt electrode regions, herein referred to as fixed electrode regions or fixed bias electrode regions 47. In some embodiments, shunt and fixed electrode regions may compromise highly doped regions of the shunt section and the fixed waveguide layer. In other embodiments, shunt and fixed electrode regions may comprise metallic layers or pads formed on a shunt section and the fixed waveguide layer.

In some embodiments, a shunt electrode region (e.g., the pair of shunt electrode regions 49-1a, 49-1b, or 49-2a, 49-2b) may be positioned above a fixed electrode region 47 such that a vertical projection of the shunt electrode region over the fixed waveguide layer at least partially overlaps with the fixed electrode region 47. In some embodiments, providing an electrical potential difference between a shunt electrode region and a corresponding fixed electrode region, below the shunt electrode region, generates an electrostatic force between the between the shunt electrode region and the fixed electrode region causing an end region of a shunt section comprising the shunt electrode region to bend down toward the fixed waveguide region. In some such embodiments, when the shunt section bends down toward the fixed waveguide region, a shunt waveguide of the shunt section may be optically coupled to a bus waveguide below the shunt waveguide.

In some embodiments, a shunt section (e.g., an L-shape shunt section) may comprise a first end region and a second end region. In some such embodiments, the shunt section may comprise a shunt waveguide extending from the first end region to the second end region. In some embodiments, the shunt waveguide may comprise a first coupling region at or near the first end region and a second coupling region at or near the second end region. In some cases, a coupling region of the shunt waveguide in a shunt section may be configured to be optically coupled to a bus waveguide when the corresponding end region of the shunt section bends toward an underlying bus waveguide (e.g., as a result of providing an electric optional difference between shunt electrode regions of the end region and the underlying fixed electrode regions). In some embodiments the shunt electrode regions at end regions of a shunt section may comprise a pair of conductive regions 49-1a, 49-1b (or 49-2a, 49-2b) separated by a shunt waveguide of the shunt section. In some embodiments the fixed electrode regions may comprise a pair of conductive regions 47 of the fixed waveguide layer separated by a shunt waveguide of the shunt section.

In some embodiments first, second, and third TSVs or electrical feedthroughs 61-1, 62-1, 61-2, may be configured to provide electrical access to different electrode regions of the MEMS optical switches via conductive contact pads 61-1a, 62-1a, and 61-2a. In some embodiments, the base substrate 63 may comprise a first major surface, e.g., major surface of the fixed waveguide layer 42 and an opposing second major surface, on or at which the conductive pads 61-1a, 62-1a, and 61-2a are formed. In some cases, an electrical feedthrough may extend (e.g., vertically) from a conductive pad at or on the second major surface of the base substrate 63 to a conductive region of the fixed waveguide layer 42. The electrical feedthroughs 61-1, 62-1, 61-2 comprise respective vertical vias (e.g., a through-substrate vias or TSV) 61-1b, 62-1b, 61-2b vertically extending through the lower insulating layer 59, and the first and second base sublayers 69a, 69b and having a terminal end exposed at the second major surface to form or connect to respective ones of the conductive contact pads 61-1a, 62-1a, 61-2a.

In some embodiments, the fixed waveguide layer 42 may comprise an electrically conductive layer (e.g., a highly doped silicon layer with doping levels greater than 10¹⁷ cm⁻³) having insulting regions formed therein. In some embodiments, the insulting regions may comprise bus waveguides (e.g., the first and second bus waveguides 25-1, 25-2) and the electrical isolation regions 65-1, 65-2, 65-3, 65-4, and 65-5. In some cases, the electrical isolation regions 65-1, 65-2, 65-3, 65-4, and 65-5 may be configured to electrically isolate conductive regions of the fixed waveguide layer 42 serving as (or electrically connected to) fixed electrode regions and other conductive regions electrically connected to shunt electrode regions, e.g., vias conductive posts 122. As illustrated, the electrical isolation regions 65-1, 65-2, 65-3, 65-4, and 65-5 may be trench isolation regions and can vertically extend substantially through an entire thickness of the fixed waveguide layer 42.

In some embodiments, a conductive region of the shunt section and the fixed waveguide layer may comprise a doped region (e.g., a doped semiconductor region). In some cases, a doping level or density of a conductive region can be at least ten time greater than that of a non-conductive or semiconductive region (e.g., an insulating region, an isolation region, an electrical isolation region, a bus waveguide, a shunt waveguide).

In some embodiments, the first shunt section 135-1 may comprise an electrically conductive layer (e.g., a highly doped silicon layer with doping levels greater than 10¹⁸ cm⁻³). In some embodiments, the first shunt waveguide 133-1 may comprise an insulting region electrically isolating the conductive regions of the first shunt section 135-1 at opposite lateral sides of the first shunt waveguide 133-1. In some cases, conductive regions of the first shunt section 135-1 may comprise shunt electrode regions (e.g., the shunt electrode regions 49-1a, 49-1b). In some cases, the shunt electrode regions 49-1a, 49-1b, of the first shunt section 135-1 can be electrically connected to a first electrical feedthrough 62-1 via the conductive posts 122-1. In some cases, the first shunt section 135-1 may comprise two end regions 48a, 48b, configured to be actuated to couple respective end regions of the first shunt waveguide 133-1 to the first and third bus waveguides 25-1, 15-1. In some embodiments the two end regions 48a, 48b, may comprise two electrically isolated or electrically connected shunt electrode regions 49-1a, 49-1b. In some cases, shunt electrode regions 49-1a, 49-1b of each end region of the first shunt section 135-1 may be electrically connected to the first electrical feedthrough 62-1 via different ones of the conductive posts 122-1.

In some embodiments, conductive posts 122-1 may be electrically connected to the first electrical feedthrough 62-1 via different conductive regions of the fixed waveguide layer 42. In some cases, these conductive regions may be electrically isolated from the remaining regions of the fixed waveguide layer 42 by different electrical isolation regions. An isolation region can form a closed insulating loop formed within the conductive layer, thereby enclosing and electrically isolating a conductive region from the surrounding conductive regions. In some cases, the MEMS structural layer may comprise one or more conducive bridges (not shown in FIG. 3A) configured to electrically connect two electrically isolated conductive regions.

For example, with reference to FIG. 3B, shunt electrode regions 49-1a, 49-1b, of a first end region 48a of the first shunt section 135-1 may be electrically connected to a first conductive region isolated by a first isolating loop 65-1 and to a second conductive region isolated by a second conductive loop 65-2. The first and second conductive regions can be electrically connected, e.g., shorted, by a first conductive bridge 36-1. In some embodiments, the first and second conductive regions can be electrically connected to the shunt electrode regions 49-1a, 49-1b, at opposite lateral sides of and separated by the first shunt waveguide 133-1 (at the first end region of the first shunt section 135-1). Accordingly, the first conductive bridge 36-1 can provide an electrical connection between the shunt electrode regions on opposite sides of the first shunt waveguide 133-1, at the first end region of the first shunt section 135-1, which would otherwise be electrically isolated by the presence of the first shunt waveguide 133-1. Similarly, shunt electrode regions of a second end region 48b of the first shunt section 135-1 may be electrically connected to a third conductive region isolated by a third isolating loop 65-3 and to the second conductive region isolated by a second isolating loop 65-2. The third and second conductive regions can be electrically connected by a second conductive bridge 36-2. In some embodiments, the third and second conductive regions can be electrically connected to shunt electrode regions 49-1a, 49-1b, at opposite lateral sides of the first shunt waveguide 133-1 (at the second end region 48b of the first shunt section 135-1). Accordingly, the second conductive bridge 36-2 can provide an electrical connection between the shunt electrode regions 49-1a, 49-1b, on opposite sides of and separated by the first shunt waveguide 133-1, at the second end region 48b of the first shunt section 135-1, which would otherwise be electrically isolated by the presence of the first shunt waveguide 133-1. In some embodiments, one or more conductive bridges 36-3, 36-4, may electrically connect conductive regions of the fixed waveguide layer 42 which are outside of the isolating loops but may have been isolated by the bus waveguides. For example, a third conductive bridge 36-3 may electrically connect conductive regions of the fixed waveguide layer 42 at opposite sides of the third bus waveguide 15-1.

In some embodiments, the first electrical feedthrough 62-1 can be electrically connected to the second conductive region isolated by a second isolating loop 65-2. In some such embodiments, the first electrical feedthrough 62-1 can be electrically connected to shunt electrode regions at both end regions of the first shunt section 135-1. In some embodiments, the second electrical feedthrough 61-1 can be electrically connected to conductive regions of the fixed waveguide layer outside of the isolating loops. These conductive regions may comprise fixed electrode regions below the shunt electrode regions. In some embodiments, the first shunt section 135-1 may be actuated by establishing an electric potential difference between the first and second electrical feedthroughs 62-1, 61-1, and thereby generating an attractive electrostatic force between the shunt electrode regions and the respective fixed electrode regions below the shunt electrode regions. In some embodiments, the second electrical feedthrough 62-1 can be connected to a ground potential and the second electrical feedthrough 61-1 can be electrically connected to a voltage source. In some other embodiments, the second electrical feedthrough 61-1 can be connected to a ground potential and the second electrical feedthrough 62-1 can be electrically connected to a voltage source.

In some embodiments, the second shunt section 135-2 may comprise one or more features described above with respect to the first shunt section 135-1. In some cases, the shunt electrode regions of the second shunt section 135-2 can be electrically connected to the third first electrical feedthrough 62-1 via the conductive posts 122-2. In some embodiments, the shunt electrode regions of the second shunt section 133-2 may be electrically connected to a fourth electrical feedthrough (not shown) and the respective fixed electrode regions below those shunt electrode regions may be electrically connected to the third electrical feedthrough 61-2. In some such embodiments, the second shunt section 135-2 may be actuated by establishing an electric potential difference between the third and fourth electrical feedthroughs.

In some embodiments, the third and fourth electrical feedthroughs which control actuation of the second shunt section 135-2 can be electrically isolated from the first and second electrical feedthroughs 62-1, 61-1, that control actuation of the first shunt section 135-1. For example, the third electrical feedthrough 62-1 can be electrically isolated from the first electrical feedthrough 62-1 by the isolation region 65-5.

In some embodiments, the electrical feedthroughs formed in the base substrate 63, conductive regions of the fixed waveguide layer 42, and the conductive bridges and posts of the optical switching layer 67 may be configured to allow independent actuation of the first and second shunt sections 135-1, 135-2.

In some embodiments, the first and second actuation voltages supplied to the first and second shunt sections 135-1 and 135-2 may be referenced to a common reference potential, e.g., ground. For example, the second and third electrical feedthroughs 62-1, 61-2, can be electrically connected to each other (e.g., through a conductive region of the fixed waveguide layer 42), and to ground potential such that the fixed electrode regions under both first and second shunt sections 135-1, 135-2, are grounded. As such, supplying independent actuation voltages to the first electrical feedthrough 62-1, electrically connected to the shunt electrode region of the first shunt section 135-1, and the fourth electrical feedthrough (not shown), electrically connected to the shunt electrode region of the section shunt section, can independently actuate them (bend them toward the respective fixed electrode regions.

In some embodiments, the integrated optical switch package 45 may comprise an optical edge coupler 14 configured to optically couple a bus waveguide to an optical source or to an optical waveguide separate from the optical switch array die. In some embodiments, the optical edge coupler 14 may be terminated an optical facet 68 formed on a side wall of the MEMS substrate 66. In some embodiments, a bus waveguide of the integrated optical switch package 45 switch array may be terminated at the optical facet 68. In various implementations the optical facet 68 may comprise an etched, cleaved, or diced facet.

In some embodiments, the base substrate 63 may comprise a base section of a silicon-on-insulator substrate including a thin silicon layer (the fixed waveguide layer 42), a buried oxide layer (the first base sublayer 69a comprising), and a thick silicon substrate or wafer (the second base sublayer 69b).

### Fabrication of Integrated Optical Switch Package

In some embodiments, the integrated optical switch package 45 may be fabricated by first providing or fabricating the MEMS substrate 66. In some cases, fabricating the MEMS substrate 66 may comprise forming the bus waveguides and the optical switching layer 67 on the base substrate, and processing the base substrate to form electrical feedthroughs. The fabrication of the optical switching layer 67 may comprise processing different layers of the optical switching layer to form the bus optical waveguides, the shunt optical waveguides and the electromechanical actuators configured to move the shunt optical waveguides. Next, the capping layer or substrate 64 may be bonded to the MEMS substrate 66 to form the integrated optical switch package 45. In some cases, the integrated optical switch package 45 may include a sealed (e.g., hermetically sealed) enclosure or cavity that houses the MEMS optical switches and bus waveguides while separating from the surrounding environment, while providing electrical and optical access via conductive contact pads formed on a major surface of the package and optical ports formed on a side wall.

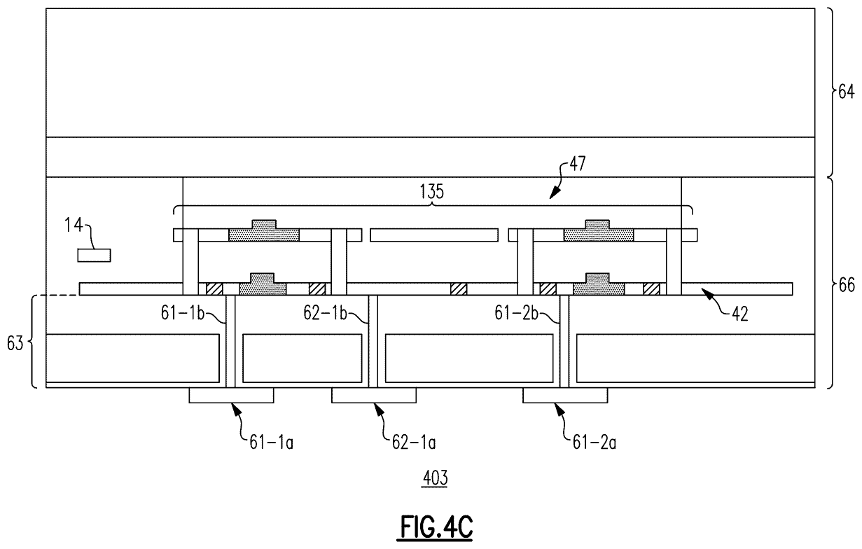

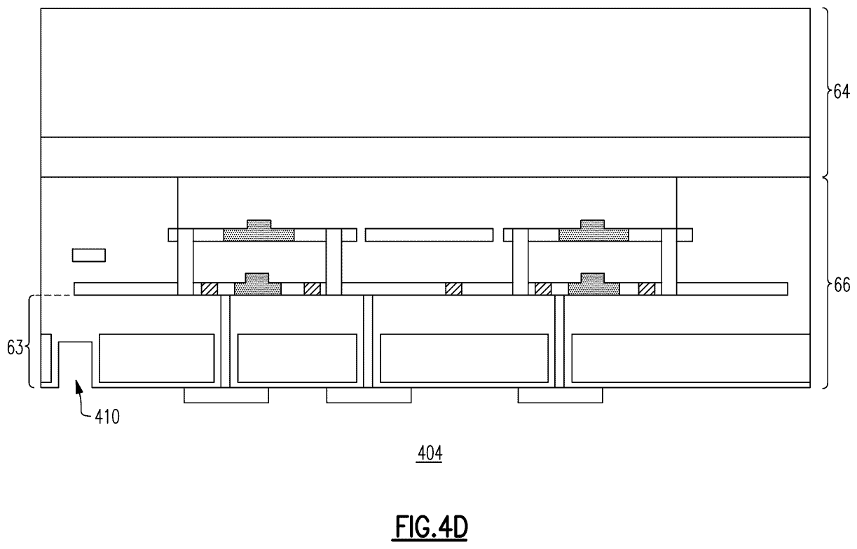

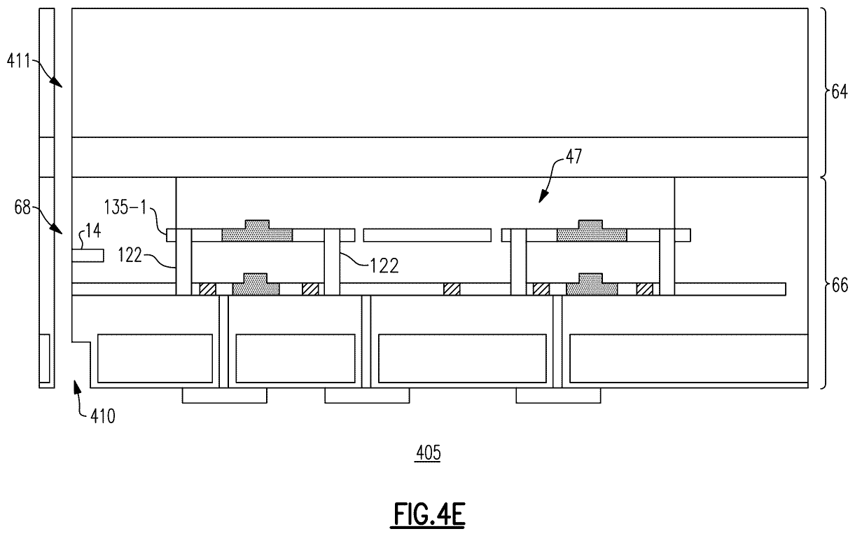

FIGS. 4A-4C schematically illustrate side cross-sectional views of representative intermediate structures at some of the stages in the fabrication process of the integrated optical switch package 45 depicted in FIG. 3A.

In some embodiments, the MEMS substate 66 may be fabricated by providing an initial substrate and forming the fixed waveguide layer 42 and the MEMS structures may be formed thereover. In some embodiments, the initial substrate 400 may include an initial base layer 430 and the first base sublayer 69a thereon. In some other embodiments, the initial substrate 400 as provided may include an initial top layer thereon. In some other embodiments, the initial top layer may be formed over the initial substrate 400.

In some embodiments, the initial top layer may comprise a silicon (Si) or a silicon nitride (SiN) layer. In some examples, the silicon layer may comprise a single crystal Si layer, polysilicon layer, or an amorphous Si layer. In various implementations the Si layer may be grown, deposited, or bonded on the first base sublayer 69a. The first base sublayer 69a may comprise a dielectric layer such as a silicon dioxide (SiO₂) layer.

In some embodiments, a thickness of the initial top layer along a vertical direction perpendicular to a main surface of initial substrate 400 can be from 0.1 to 0.2 micron, from 0.2 to 0.3 micron, from 0.3 to 0.5 micron, from 0.5 to 1 micron, from 1 micron to 1.5 microns, from 1.5 to 2 microns, or any ranges formed by these values or larger or smaller values. In some embodiments, thickness of the first base sublayer 69a can be from 1 micron to 1.5 micron, from 1.5 to 2 microns, from 2 to 3 microns, from 3 to 4 microns, from 4 to 5 microns, from 5 to 6 microns, or larger values.

In some embodiments, an optical grade silicon-on-insulator (SOI) substrate may serve as the initial substrate 400 and the initial top layer. For example, the initial top layer can be a thin silicon layer (e.g., 200-300 nm) of the SOI substrate, the first base sublayer 69a can be a buried oxide layer of the SOI substrate, and the initial base layer 430 can be a base silicon layer of the SOI substrate.

In some embodiments, the initial top layer may be processed to form the fixed waveguide layer 42 comprising bus optical waveguides, conductive regions, and insulating regions (e.g., isolating loops).

In some embodiments, the initial top layer may comprise a conductive layer (e.g. a highly doped semiconductor layer such as highly doped silicon). In some such embodiments, a plurality of bus waveguides (e.g., the bus waveguides 25-1, 15-1, 25-2, 15-2) may be formed on and/or within the initial top layer.

In some embodiments, the initial top layer can be an undoped silicon layer and may be selectively doped, e.g., by masking and implanting dopant atoms, to form conductive regions. Different conductive regions are electrically isolated from each other by forming isolation regions, e.g., isolation loops as described herein. In some such embodiments, a plurality of bus waveguides (e.g., the bus waveguides 25-1, 15-1, 25-2, 15-2) may be formed by processing the undoped regions of the initial top layer.

In some embodiments, mechanical support structures (e.g., posts and clamping structures) may be formed on the top layer (fixed waveguide layer 42). In some cases, a sacrificial layer may be formed over the fixed waveguide layer and the mechanical support structures may be formed within the sacrificial layer. In some embodiments, some of the mechanical support structures may comprise conductive structures such as metallic post or heavily doped semiconductor structures. In some cases, the sacrificial layer may comprise an inorganic material (e.g., SiO₂). In some cases, the sacrificial layer can be an organic sacrificial layer comprising an organic material such as polymer (e.g., a photoresist material, e.g., SU-8, polyimide). In various implementations, the sacrificial layer may be disposed by a polymer deposition process, lamination, bonding, spin coating, or other methods. In some examples, the sacrificial layer may comprise a material that can be removed by an etching process that does not substantially affect the surrounding layers and structures upon completion of the mechanical optical switch. In some cases, the etching process may comprise wet etching using a solvent or dry etching using oxygen plasma. As such, in some cases, the composition of the sacrificial layer may be determined, based at least in part, on the composition and properties of the fixed waveguide layer 42 and the first base sublayer 69a.

In some embodiments, an initial suspended layer may be formed over the sacrificial layer and mechanical support structures embedded therein. The initial suspended layer may be processed to form the suspended waveguide layer 135 comprising shunt sections (e.g., first and second shunt sections 135-1,135-2). In some cases, fabricating the shunt sections may comprise shunt waveguides (e.g., the first and second shunt waveguides 131-1, 131-2).

In some embodiments the sacrificial layer may be removed to release the shunt sections and the mechanical support structures. In some cases, the sacrificial layer may be selectively removed in regions that include the bus waveguides, the shunt sections, the mechanical support structures, and other components associated with the MEMS optical switches, thereby forming an opening 47 that contains the optical MEMS switches and the bus waveguides. FIG. 4A schematically illustrates a side cross-sectional view of the MEMS substrate 66 after fabrication of first and second bus waveguides 25-1, 25-2, the conductive posts 122-1, 122-2, and the first and second shunt waveguide sections 135-1, 135-2. In some cases, an edge optical coupler 14 may be fabricated within the optical switching layer 67 (e.g., within a portion of the sacrificial layer surrounding the opening 47).

In various implementations, the MEMS optical switches, may be fabricated on the MEMS substrate 66 using different methods including fabricating a MEMS optical switch on a single multilayer substrate or fabricating portions of a MEMS optical switch on two different substrates and then bonding the two substrates.

In some embodiments, in preparation for forming electrical feedthroughs from the backside of the intermediate structure 401, the thickness of the initial base layer 430 may be substantially reduced, e.g., down to 10-100 μm, and a lower insulating layer 59 may be formed on a major surface of the resulting thinned base substrate to form the MEMS substrate 66.

In some embodiments, the conductive posts 122-1, 122-2, may be configured to electrically connect a conductive region (e.g., a heavily doped region) of the suspended waveguide layer 135 to a conductive region (e.g., a heavily doped region) of the fixed waveguide layer 42. In some such embodiments, the conductive posts 122-1 or 122-2 may be additionally configured to mechanically support the suspended waveguide layer 135. For example, the conductive posts 122-1 or 122-2 may set/define a vertical separation between the suspended waveguide layer 135 and the fixed waveguide layer 42. In some other embodiments, the conductive posts 122-1, 122-2, may not mechanically support the suspended waveguide layer. In some cases, the conductive posts 122-1, 122-2, may be integrated with or function in parallel with mechanical clamping and/or support structures configured to mechanically support the suspended waveguide layer 135.

In some embodiments, the capping layer or substrate 64 may be bonded to the resulting MEMS substrate 66 to seal the opening 47. FIG. 4B schematically illustrates a side cross-sectional view of an intermediate structure 402 formed after processing the initial base layer 430 bonding the capping layer 64. In some cases, the intermediate structure 402 may comprise the integrated optical switch package 45 contained in a substrate along with other integrated optical switch packages or other devices.

In some embodiments, electrical feedthroughs may be formed in the base substrate 63. In certain cases, an electrical feedthrough may be fabricated by forming a conductive through-substrate via (TSV) through the base substrate 63 and, in some cases, forming a conductive contact pad on the lower insulating layer 59, where the conductive contact pad is electrically connected to the conductive through-substrate via. In some cases, forming a conductive through-substrate via may comprise etching a hole that extends from an exposed major surface of the lower insulating layer 59 to a conductive region of the fixed waveguide layer 42, oxidizing the sidewalls of the hole to form an insulating layer, and then filling the hole with a conductive material (e.g., a metal such as aluminum, gold, or the like), e.g., by a suitable process such as physical or chemical vapor deposition, or by electroplating. FIG. 4C schematically illustrates a side cross-sectional view of a device region 403 (pre-diced die) of a wafer, formed after fabricating the electrical feedthrough, depicting the first electrical feedthrough 62-1 comprising a first conductive through-substrate via 62-1b and a first conductive contact pad 62-la, the second electrical feedthrough 61-1 comprising a second conductive through-substrate via 61-1b and a second conductive contact pad 61-1a, and the third electrical feedthrough 61-2 comprising a first conductive through-substrate via 61-2b and a first conductive contact pad 61-2a.

In some embodiments, the integrated optical switch package 45 may be singulated (e.g., separated) from a main wafer on which the MEMS substrate 66 is fabricated. In various embodiments, singulation may comprise cutting, dicing, or otherwise dividing the processed main wafer into individual chips, dies, or packages, e.g., using a dicing saw, a laser, or other wafer-separation tools.

In some embodiments, individual MEMS optical switches of integrated optical switch package 45 can be electrically isolated to allow independent control of each MEMS optical switch using the respective contact pads connected to the MEMS optical switches by conductive through-substrate vias. In some implementation, a MEMS optical switch may be electrically isolated from adjacent MEMS optical switches at least partially by isolating regions (e.g., isolating loops) formed in a fixed waveguide layer comprising bus waveguide. In some examples, an isolating region may comprise a bus waveguide of the MEMS optical switch array, an oxidized region of the fixed waveguide layer, or a dielectric-filled trench formed in the fixed waveguide layer. In some examples, an isolation region may comprise Al₂O₃, SiN, or other insulating materials. In some embodiments, an isolating region may comprise an air gap (an air-filled trench).

### Singulation and Optical Facet Formation

In some embodiments, singulating the integrated optical switch package 45 may comprise formation of an optical facet to form an optical input port via the optical edge coupler 14. In some such embodiments, singulating the integrated optical switch package 45 may comprise cutting or cleaving the MEMS substrate 66 and the capping layer or substrate 64 along a surface substantially perpendicular to a major surface of the initial base layer 430 and passing through the optical edge coupler 14. In some examples, cleaving the MEMS substrate 66 may form having sufficiently low roughness to serve as an optical facet without further processing. In some embodiments, after cutting or cleaving, a resulting sidewall of the MEMS substrate 66 comprising an input surface of the optical edge coupler 14 may be processed (e.g., polished) to form an optical facet.

In some embodiments, the optical facet 68 may comprise a plurality of waveguide facets serving as optical ports to the bus waveguides of the integrated optical switch package 45 configured to allow optical coupling of the bus waveguides to external optical waveguides and optical source.

FIGS. 4D-4E schematically illustrate side cross-sectional views of the integrated optical switch package 45 at two stages of separating the optical switch-array package shown in FIG. 4C from the main wafer and forming the optical facet 68, by dicing or cleaving. In some embodiments, at a first separation stage a trench 410 may be formed in the base substrate 63, e.g., to outline die boundaries and/or localize later dicing or cleaving stresses. A horizontal surface of the trench 410 can at least partially over the optical edge coupler 14 (FIG. 4C). At a second separation stage, the integrated optical switch package 45 may be separated by cutting or cleaving the MEMS substrate 66 and the capping layer 64 along a surface substantially perpendicular to a major surface of the MEMS substrate 66 and passing through the trench 410 and the optical edge coupler 14. In some embodiments, the sidewall 411 may comprise the optical facet 68. In some other embodiment at least a portion of the sidewall 411 formed upon separation may be polished to form the optical facet 68 (FIG. 4E).

In some embodiments, a region of the external major surface of the MEMS substrate 66 near the optical facet 68 may be etched and the etched region may be filled by an oxide (e.g., silicon dioxide) to enhance optical between an optical waveguide of the sealed MEMS optical switch array and an external optical waveguide.

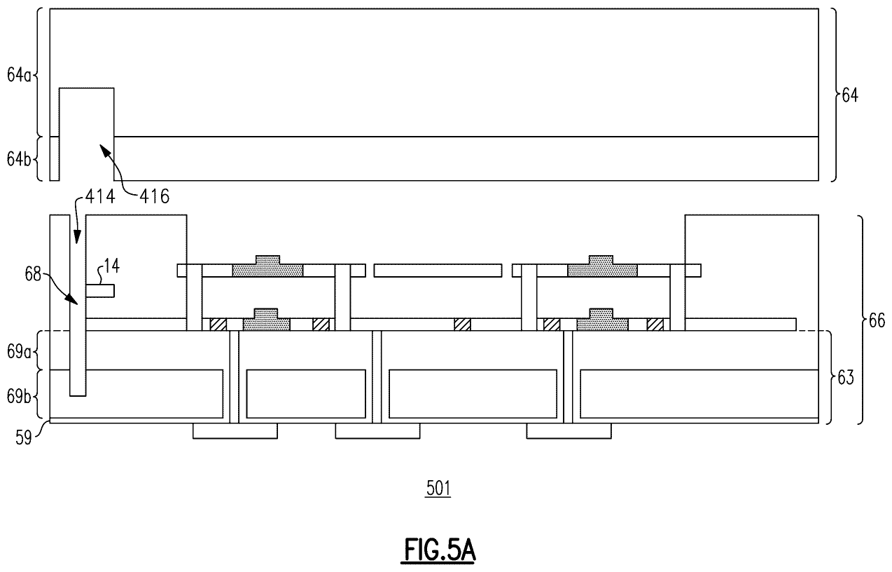

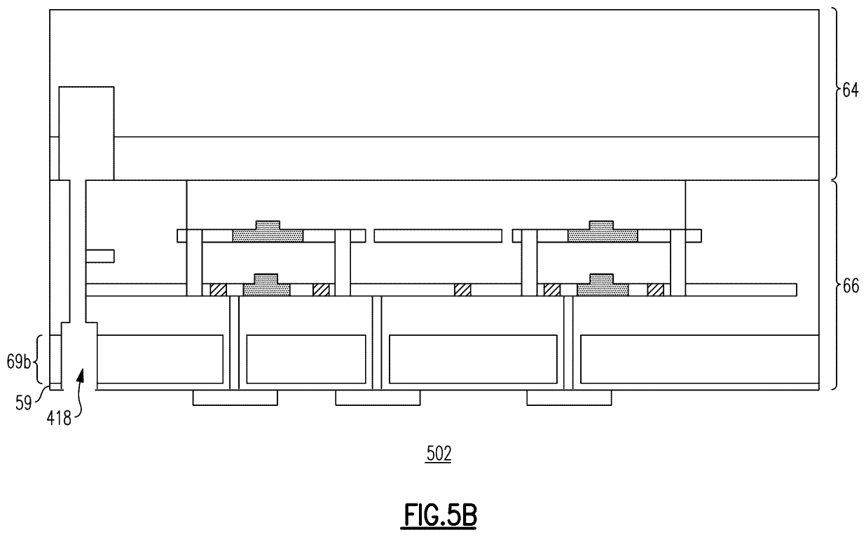

In some embodiments, the optical facet 68 of the integrated optical switch package 45 array may be formed before bonding the capping layer 64 and the MEMS substrate 66 and before separating the integrated optical switch package 45 from a main wafer or structure that may comprise multiple copies of the integrated optical switch package 45 or other devices. FIGS. 5A-5C schematically illustrate side cross-sectional views of representative intermediate structures at some of the stages in the fabrication process of the optical facet 68 via etching and separating the integrated optical switch package 45 by dicing or cleaving.

In some embodiments, a first trench 414 may be formed in the MEMS substrate 66 and a second trench 416 may be formed in the capping layer 64. In some cases, the first trench 414 (e.g., a deep trench) may vertically extend from a top surface of the MEMS substrate 66 above the optical edge coupler 14 to a vertical position below an interface between the first and second base sublayers 69a, 69b of the base layer 63. In some cases, the second trench 416 may vertically extend from a major surface the capping layer 64 to a vertical position between an interface between the first and second capping sublayers 64a, 64b, and an opposing major surface of the first capping sublayer 64a. FIG. 5A schematically illustrates a side cross-sectional view of MEMS substrate 66 and the capping layer 64 comprising the first and second trenches 414, 416, respectively. In some cases, the formation of the first trench 414 may comprise formation of an optical facet 68 comprising an end facet of the optical edge coupler 14 or an end facet of a bus waveguide of the corresponding optical switch matrix. In some cases, a side wall of the first trench 414 may comprise the optical facet 68. In some such cases, a process used to form the first trench 414 may be tailored to form a smooth side wall configured to serve as the optical facet 68.

Next the MEMS substrate 66 and the capping layer 64 may be positioned and aligned with respect to each other, e.g., to align the first and second trenches 414, 416, and then bonded such that the first and second trenches 414, 416, form cavity. After bonding the MEMS substrate 66 and the capping layer 64, portions of the lower insulating layer 59 and the second base sublayer 69b overlapping with the first trench 414 may be etched to expose the cavity formed by the first and second trenches 414, 416. FIG. 5B schematically illustrates a side cross-sectional view of the structure resulting from bonding MEMS substrate 66 and the capping layer 64 and exposing the cavity formed by the first and second trenches 414, 416.

Next, the remaining portion of the capping layer 64 between the second trench 416 and an exposed major surface of the capping layer 64 may be etched to detach (singulate) the integrated optical switch package 45 from a structure (e.g., two bonded wafers) that may comprise one or more other integrated optical switch packages.

Advantageously, the process described above with respect to FIGS. 5A-5C may facilitate separation of the integrated optical switch package 45 by eliminating the need for cleaving and/or polishing a singulated device (e.g., a die), which can be challenging due to small size of the die and the risk of causing structural damage to the enclosure and the optical switches therein during the fabrication process.

### Additional Embodiments and Features

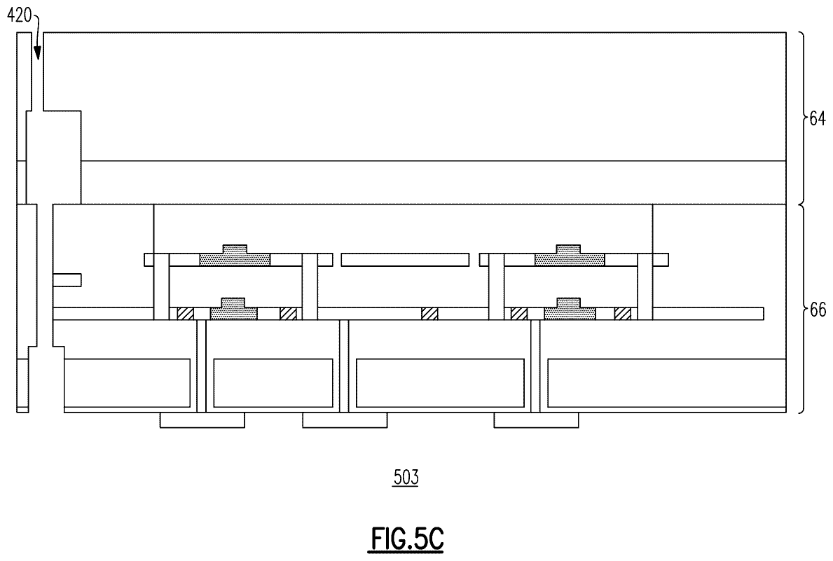

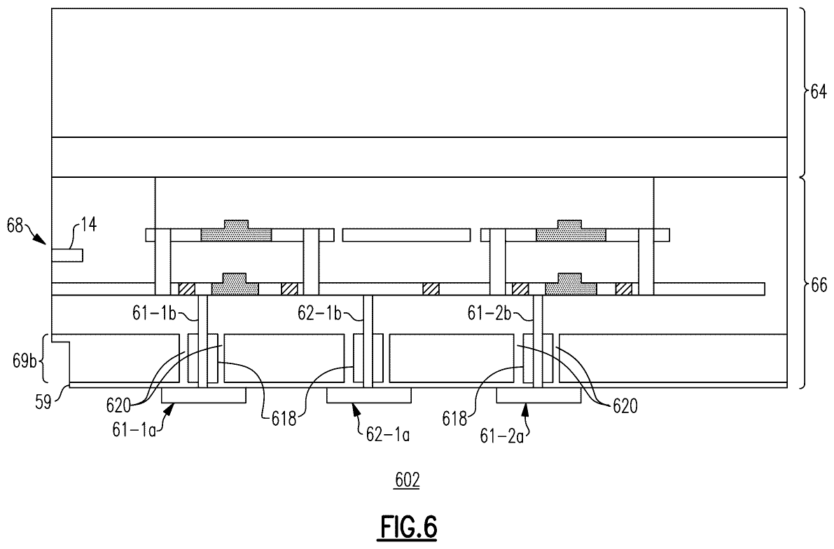

In some embodiments, the through-substrate vias formed in the base substrate 63 can be electrically isolated from the second base sublayer 69b of the base substrate 63 by isolating trenches 620 instead of forming insulating layers in a hole within which a conductive via is formed. In some cases, an isolating trench may comprise a trench formed in the lower insulating layer 59 and the second base sublayer 69b, around the TSV 61-1b, 62-1b, 61-2b, and filed with a dielectric material such as an oxide (e.g., silicon dioxide). FIG. 6 schematically illustrates a side cross-sectional view of an integrated optical switch package 602 comprising isolation trenches. The integrated optical switch package 602 may comprise one or more features described above with respect to the integrated optical switch package 45. In the example shown the first, second, and third through-substrate vias 62-1b, 61-1a, and 61-2a, are formed in electrically isolated regions 618 of the second base sublayer 69b. In some cases, each of the electrically isolated regions 618 of the second base sublayer 69b can be electrically isolated from other regions of the second base sublayer 69b by a dielectric filled trench 620 surrounding an individual electrically isolated regions 618 within which at least a portion of a through-substrate vias is formed.

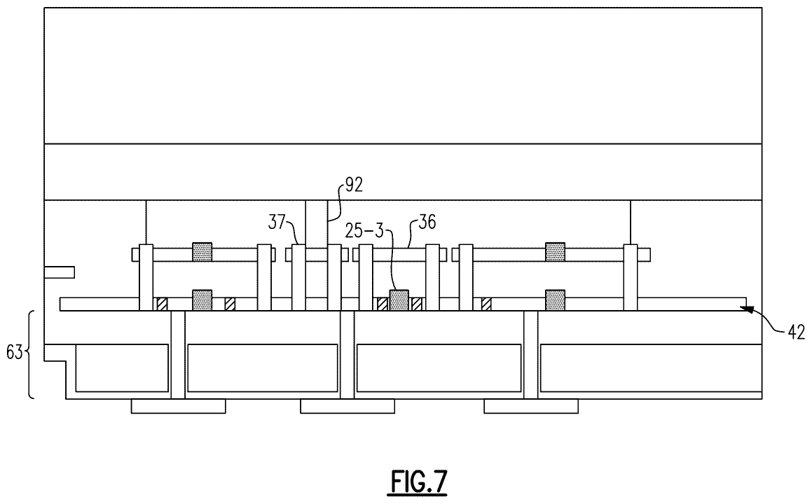

In some cases, the MEMS substrate 66 may comprise spacers and bonding structures, e.g., between or surrounding MEMS optical switches, and configured to bond to the capping layer 64 and/or provide vertical spacing between the base substrate 63 and/or he fixed waveguide layer and the capping layer 64. FIG. 7 schematically illustrates another side cross-sectional view of the integrated optical switch package 45 depicting a support post 92 and two conductive bridges 37, 36, electrically connecting different regions of on the fixed waveguide layer. In some cases, the conductive bridge 36 may electrically connect two conductive regions of the fixed waveguide layer 42 that would be otherwise electrically isolated by a bus waveguide 25-3.

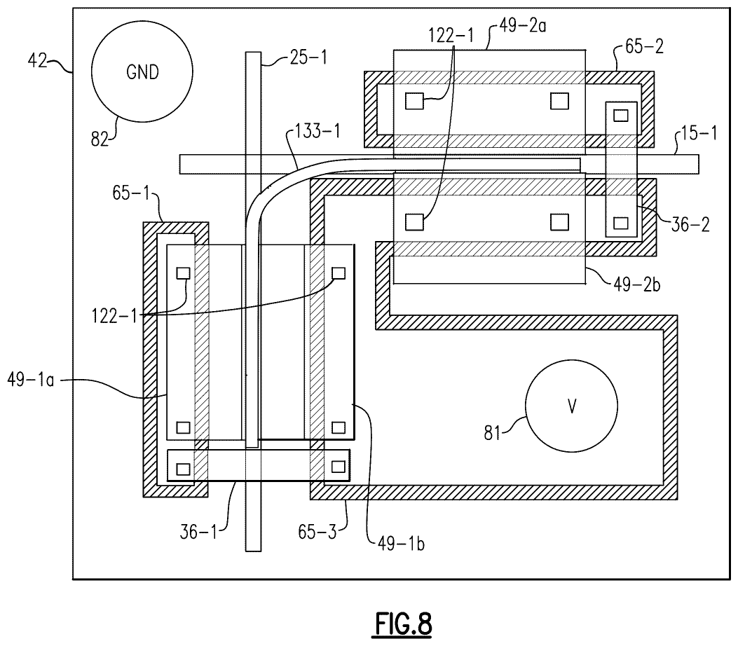

FIG. 8 schematically illustrates a top cross-sectional view of a portion of another integrated optical switch package near a waveguide crossing, depicting the first and third bus waveguides 25-1, 15-1, and a shunt waveguide 133-1 configured to optically connect the first and third bus waveguides 25-1, 15-1, upon being actuated. The integrated optical switch arrangement shown in FIG. 8 may comprise one or more features described above with respect to the integrated optical switch packages shown in FIGS. 1B, 2A, 3A-3C. The first shunt section of the integrated optical switch package may comprise a first pair of shunt electrode regions 49-1a, 49-1b, formed at lateral sides of a first end region of the shunt waveguide 133-1 (above the third bus waveguide 15-1), and a second pair of shunt electrode regions 49-2a, 49-2b, formed at lateral sides of a second end region of the shunt waveguide 133-1 (above the first bus waveguide 25-1). In some embodiments, the first and second pairs of shunt electrode regions 49-1a, 49-1b, 49-2a, 49-2b, can be electrically connected to a first electrical feedthrough 81 and the respective fixed electrode regions can be electrically connected to a second electrical feedthrough 82. In some cases, the fixed electrode regions may comprise conductive regions of the fixed waveguide layer 42 at least partially overlapping with vertical projections of the shunt electrode regions 49-1a, 49-1b, 49-2a, 49-2b. In some cases, the shunt electrode region 49-1a can be electrically connected to a first conductive region of the fixed waveguide layer 42 within a first isolating loop 65-1, the shunt electrode region 49-1b can be electrically connected to a third conductive region of the fixed waveguide layer 42 within a third isolating loop 65-1, and the first and third conductive regions can be electrically connected via a first conductive bridge 36-1. In some cases, the shunt electrode region 49-2a can be electrically connected to a second conductive region of the fixed waveguide layer 42 within a second isolating loop 65-2, the shunt electrode region 49-2b can be electrically connected to the third conductive region of the fixed waveguide layer 42 within a third isolating loop 65-1, and the second and third conductive regions can be electrically connected via a second conductive bridge 36-2. The electrical connection between shunt electrode regions and respective conductive regions of the fixed waveguide layer 42 may be provided by conductive posts 122-1. The first electrical feedthrough 81 may be electrically connected to the third conductive region and thereby to the first and second pairs of the shunt electrode regions 49-1b, 49-2a, 49-2b. The second electrical feedthrough 82 (e.g., ground potential) may be electrically connected to the fixed electrode regions formed on or within the fixed waveguide layer 42, below the respective shunt electrode regions 49, via the conductive regions of the fixed waveguide layer 42 our side of the isolating loops.

It should be understood that arrangements of isolating loops shown in FIG. 3B and FIG. 8 are non-limiting examples. In various embodiments, isolating loops with different geometries or, in some cases, isolating sections that do not form a closed loop, may be formed in the fixed waveguide layer 42 to electrically connect first and second electrically isolated feedthroughs to the fixed and shunt electrode regions, respectively, and to electrically isolate the fixed electrode regions from the shunt electrode regions. In some cases, an electrical path between a shunt electrode region and an electrical feedthrough may comprise a conductive post, a conductive region of the fixed waveguide layer 42, a conductive bridge, or a combination thereof.

In some embodiments, the fixed waveguide layer 42 may comprise an insulating layer and electrical connections between the first and second electrically isolated feedthroughs 81, 82 and the fixed and shunt electrode regions may be provided by forming conductive regions (e.g., conductive pads and traces) on or over the fixed waveguide layer 42.

In some embodiments, a conductive bridge may comprise two conductive posts extending vertically between the fixed waveguide layer 42 and the suspended waveguide layer 135, and a laterally extended conductive region electrically that is vertically separated from the fixed waveguide layer 42 and electrically connects the two conductive posts. In some cases, the laterally extended conductive region may comprise a conductive region of the suspended waveguide layer 135 or a conductive pad formed in the suspended waveguide layer 135.

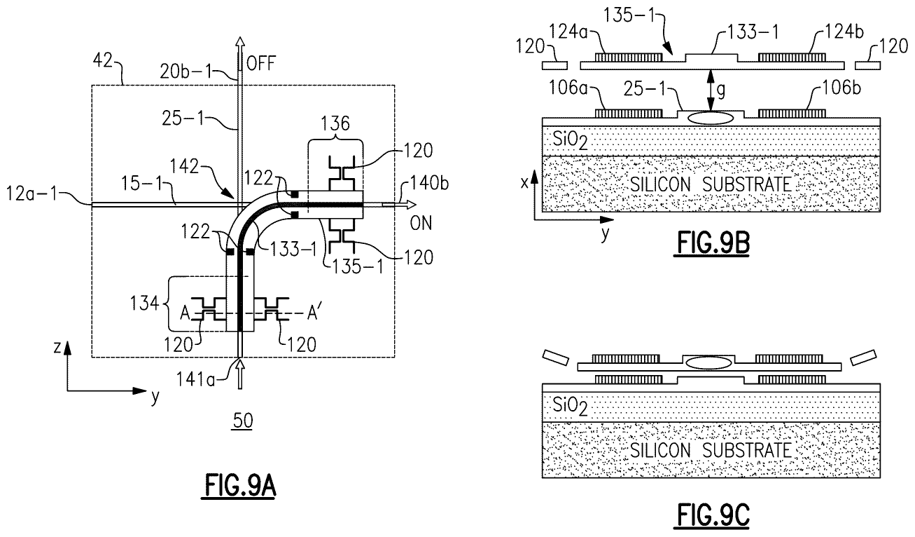

FIG. 9A schematically illustrates a top-down view (e.g., in a plane parallel to a major surface of the base layer 63) of an example MEMS optical switch 50 fabricated on a multilayer substrate. For example, FIG. 9A can be a top view of an example MEMS optical switch in the MEMS optical switch in the integrated optical switch package 45 depicting a waveguide crossing region 142, the first shunt section 135-1, and the mechanical structures supporting the first shunt section 135-1. In some embodiments, the optical switch 50 comprises a reconfigurable waveguide crossing that includes a first bus optical waveguide 25-1 and a third bus optical waveguide 15-1 which are arranged such that they cross each other at a junction (e.g., crossing region 142). In some embodiments, the bus optical waveguides (also referred to as bus waveguides) 25-1, 15-1 are substantially orthogonal to one another. In some other embodiments, the bus waveguides 25-1, 15-1 may not be orthogonal to one another. In the example shown, the first bus waveguide 25-1 optically connects a first optical port 12a-1 to a second optical port 140b of the optical network, and the third bus waveguide 15-1 optically connects a third optical port 141a to a fourth optical port 20b-1 of the optical network. In some cases, the optical ports 12a-1, 140b, 141a, and 20b-1 can be arbitrary points along the respective waveguide used to separate different switching cells and therefore may not indicate an optical discontinuity along a waveguide.

As mentioned above, the crossing region 142 may be configured to reduce or potentially eliminate propagation of light from the first or second optical ports 12a-1, 140b, to the third or fourth optical ports 141a, 20b-1, and vice versa.

The optical switch 50 may further include a suspended first shunt section 135-1 configured to controllably redirect or couple at least a portion of light propagating in one bus waveguide to the other bus waveguide. In some cases, the first shunt section 135-1 can be a structure or a patterned layer fabricated above the bus waveguides 25-1, 15-1, and may include a first shunt waveguide 133-1 configured to guide light, and one or more electrodes (or conductive regions) configured to enable electromechanical actuation of the shunt section 135. In some cases, the first shunt section 135-1 may comprise a slab region and a ridge (or rib) region configured to confine light in a transverse direction perpendicular to the direction of propagation of light in the corresponding first shunt waveguide 133-1. For example, when it is in the ON state, the first shunt section 135-1 may redirect substantially the entire optical power received from the third optical port 141a and propagating in the first bus waveguide 25-1 to the third bus waveguide 15-1 such that an amount of optical power that passes the crossing region via the first waveguide 25-1 is negligible or substantially zero. For example, when it is in the ON state, the first shunt section 135-1 may redirect more than 90%, more than 95%, more than 97%, or more than 99% of the optical power received from the third optical port 141a and propagating in the first bus waveguide 25-1 to the third bus waveguide 15-1.

In some embodiments the first shunt section 135 may comprise one or more electrodes or electrode regions configured to allow electromechanical actuation of at least a portion of the optical switch structure.

Still referring to FIG. 9A, in some examples, the first shunt section 135-1 may be at least partially suspended above the fixed waveguide layer 42 and supported by one or more support structures mechanically coupling or clamping at least a portion of the first shunt section 135-1 to the fixed waveguide layer 42. In some cases, the support structures may comprise one or more conductive clamping support structures 122 (also referred to as clamping structures), and one or more flexible support structures 120. The conductive clamping support structures 122 can be configured to clamp a portion (e.g., a middle portion) of the first shunt section 135-1 to fixed waveguide layer 42, and the flexible support structures 120 can be configured to allow the two end regions of the first shunt section 135-1 to move in a vertical direction perpendicular to a main surface of the fixed waveguide layer 42. In some embodiments, the conductive clamping support structures 122 may comprise one or more pillars (e.g., metallic pillars) extending from the first shunt section 135-1 down to the fixed waveguide layer 42. In some cases, the conductive clamping support structures 122 may comprise a metal such as aluminum, copper, or an alloy including aluminum, copper, and/or other metals. In some cases, the conductive clamping support structures 122 may comprise a dielectric material. In some cases, at least a portion of the conductive clamping support structures 122 may comprise an organic material (e.g., a polymer). In some cases, the flexible support structures 120 can mechanically connect one end of the first shunt section 135-1 to a base structure fabricated on the fixed waveguide layer 42. In some examples, at least a portion of a flexible support structure 120 may comprise a folded spring structure. The flexible support structures 120 can be connected to an end of the first shunt section 135-1 while allowing that end to bend toward the fixed waveguide layer 42, e.g., upon being actuated by an electrostatic force applied, at least partially, using an electrode of the shunt section 135. In some cases, the flexible support structure 120 partially supports the corresponding coupling region of the first shunt waveguide 133-1 and when the state of optical switch is changed from the ON state to the OFF state, helps the bent coupling region of the first shunt waveguide 133-1 to go back to its neutral position and optically decouple from the bus waveguide.

In some cases, the first shunt section 135-1 may be aligned with the bus waveguides 25-1, 15-1, such that the first shunt waveguide 133-1 can controllably shunt light from one of the bus waveguides 25-1, 15-1, to the other to change the optical connection between the optical ports associated with these waveguides. For example, when the first shunt section 135-1 is in the OFF state the first shunt waveguide 133-1 is optically decoupled from the first and third bus waveguides 25-1, 15-1 and light entering the third port 141a propagates to the fourth port 20b-1 via the crossing region 142. When the first shunt section 135-1 is in the ON state, the first shunt waveguide 133-1 is optically coupled to the first and second bus waveguides 25-1 (e.g., using electromechanical actuation), and provides an optical path that bypasses the crossing region 142 crossing region 142 and connects a portion of the first waveguide 25-1 to a portion of the third waveguide 15-1 such that light entering the third port 141a propagates to second port 140b via the first shunt waveguide 133-1.

In some embodiments, the first shunt waveguide 133-1 may comprise a first coupling region 134 (also referred to first end region), a second coupling region 136, and a middle region extended from the first coupling region 134 to the second coupling region 136 (also referred to second end region). The first coupling region 134 may extend from a first end of the first shunt waveguide 133-1 to the middle region and the second coupling region 136 may extend from a second end of the first shunt waveguide 133-1 to the middle region. The first shunt waveguide 133-1 may be positioned above the bus waveguides 25-1, 15-1, such that when the first shunt section 135-1 is in the OFF state, the first and the second coupling regions 134, 136 are vertically separated from the first and third bus waveguides 25-1, 15-1 by first and second gap sizes, respectively, and when the first shunt section 135-1 is in the ON state, the first and the second coupling regions 134, 136 are vertically separated from the first and third bus waveguides 25-1, 15-1 by third and fourth gap sizes, respectively.

In some cases, the first shunt waveguide 133-1 can be aligned with the first and third bus waveguides 25-1, 15-1, such that when the first shunt section 135-1 is in the ON state, the shunt waveguide is optically coupled to the first and third bus waveguides 25-1, 15-1 via the first and second coupling regions 134, 136, respectively.

In some cases, when the first shunt section 135-1 is in the ON state, the first and second coupling regions 134, 136, may be evanescently coupled to the first and third bus waveguides 25-1, 15-1.

In a preferred embodiment, when the first shunt section 135-1 is in the ON state, at least a portion of each of the first and second coupling regions 134, 136, are positioned immediately adjacent, but not in contact with, the first and third bus waveguides 25-1, 15-1. In some other embodiments, when the first shunt section 135-1 is in the ON state, at least a portion of each of the first and second coupling regions 134, 136 can be in contact with the first and third bus waveguides 25-1, 15-1.

In some cases, when the first shunt section 135-1 is in the ON state, the first coupling region 134 and the first bus waveguide 25-1 may form a first optical directional coupler, and the second coupling region 136 and the third bus waveguide 15-1 may form a second optical directional coupler. In some embodiments, the first and the second directional couplers may be configured to couple a specified portion of light propagating in one of the bus waveguides 25-1, 15-1, to the first shunt waveguide 133-1 and vice versa. In some cases, the specified portion can be from 1% to 5%, from 5% to 10%, from 10% to 30%, from 30% to 50%, 50% to 70%, from 50% to 70%, from 70% to 90%, from 90% to 95%, from 95% to 99%, or larger values. In some cases, one of the first or second directional couplers may be configured to couple nearly 100% (e.g., more than 98%), and the other directional may be configured to couple a specified portion within one of the ranges listed above, of light propagating in one of the bus waveguides 25-1, 15-1 to the first shunt waveguide 133-1 (and vice versa.

In some cases, when the first shunt section 135-1 is in the ON state, a specified portion of light received from the third optical port 141a and propagating in the first bus waveguide 25-1 may be transmitted to the second bus waveguide via the first shunt waveguide 133-1, and vice versa. In some cases, the specified portion can be from 50% to 70%, from 70% to 90%, from 90% to 95%, from 95% to 99%, or larger values.

In some cases, when the first shunt section 135-1 is in the OFF state, a portion of light coupled from the first bus waveguide 25-1 to the third bus waveguide 15-1 may not exceed 3%, 2%, 1%, 0.1%, 0.01%, or smaller values.

In some cases, a gap between a bus waveguide and the respective coupling region of the first shunt waveguide 133-1 may be tunable using an actuation mechanism. In some examples, the actuation mechanism may comprise a micro-electromechanical system (or MEMS) structure where a controllable electrostatic force moves the coupling region toward the bus waveguide and reduces the coupling gap. The actuator implemented may include, without limitation, electrothermal, thermal, magnetic, electromagnetic, electrostatic comb drive, magnetostrictive, piezoelectric, fluidic, pneumatic actuators, and the like. As such the strength of optical coupling between each one of the coupling regions 134, 136 of the first shunt waveguide 133-1 and the respective bus waveguide, may be controlled by electric actuation. In some embodiments, the electrostatic force may be generated and controlled by generating an electric potential difference between a region (e.g., a conductive region) of the first shunt section 135-1 and the fixed waveguide layer 42 (e.g., a conductive region of the substrate). In these embodiments, the coupling gaps, and thereby optical couplings, between the coupling regions 134, 136, and the respective one of the bus waveguides 25-1, 15-1 may be controlled or tuned by adjusting a potential difference between the corresponding portions of the first shunt section 135-1 and the fixed waveguide layer 42. For example, the state of the first shunt section 135-1 may be changed from the OFF state to the ON state, by providing potential differences between the end portions of the first shunt section 135-1 and the fixed waveguide layer 42 such the first gap size changes to the third gap size and second gap size changes to the fourth gap size. In some examples, the potential difference may be provided by a voltage source electrically connected to the conductive regions of the first shunt section 135-1 and the fixed waveguide layer 42 (e.g., via conductive lines disposed on the fixed waveguide layer 42).

In some cases, at least one of the coupling regions 134, 136 of the first shunt waveguide 133-1 may include a tapered region having a width that is tapered toward an end of the first shunt waveguide 133-1. In some examples, when a coupling region having a tapered region is actuated and bends toward the respective bus waveguide, an adiabatic optical coupler may be formed by the coupling region and the bus waveguide allowing low loss adiabatic transfer of optical power from the bus waveguide to the first shunt waveguide 133-1 and vice versa.

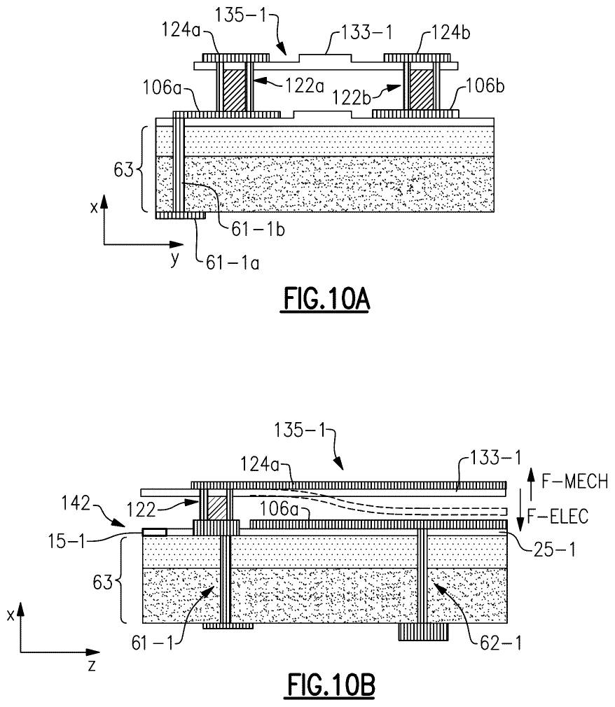

FIGS. 9B-9C schematically illustrate side cross-sectional views of a portion of the MEMS optical switch 50 in a cut plane (indicated by AA′ in FIG. 10A) when the optical switch is in the OFF state (B) and ON state (C). the cut plane is perpendicular to a major surface of the fixed waveguide layer 42 (e.g., parallel to x-axis). In FIG. 9B the first shunt section 135-1 is in the off state and the vertical gap size g between the first shunt waveguide 133-1 and the bus waveguide 25-1 below the first shunt waveguide 133-1, is large enough to prevent optical coupling between the first shunt waveguide 133-1 and the bus waveguide 25-1. in some cases, in the off state an electric potential difference between second top electrodes 124a, 124b of the first shunt section 135-1 and, bottom electrodes 106a, 106b on the fixed waveguide layer 42 can be substantially zero. In some cases, in the OFF state the vertical gap size g can be from 0.1 microns to 0.5 microns, from 0.5 microns to 1 micron, 1 micron to 2 microns, 2 microns to 3 microns, 3 microns to 4 microns, or larger values.

In FIG. 9C, the first shunt section 135-1 is actuated and is in the ON state. in some cases, the first shunt section 135-1 is actuated, e.g., by generating an electric potential difference between the top electrodes 124a, 124b of the first shunt section 135-1 and the bottom electrodes 106a, 106b on the fixed waveguide layer 42. in some examples, when optical switch is actuated a portion of the optical switch suspended over the first optical waveguide 25-1 (e.g., a portion comprising the coupling region 134) may bend down toward the bus waveguide to reduce vertical gap size g between the coupling region 134 of the first shunt waveguide 133-1 and the bus waveguide 25-1 and optically couple the first shunt waveguide 133-1 with the bus waveguide 25-1. In some cases, in the ON state the vertical gap size g can be from 0.5 micron to 0.3 micron, from 0.3 micron to 0.2 micron, from 0.2 micron to 0.1 micron, from 0.1 micron to 0.05 micron, or smaller values.

In some embodiments, the optical switch 50 shown in FIG. 9A may be fabricated on a silicon substrate using CMOS compatible fabrication methods and processes. Some embodiments and methods described below provide nonlimiting examples of fabrication steps and structural properties (e.g., geometrical and material properties) of a switching cell comprising at least one shunt waveguide controllably coupled to two bus waveguides. Advantageously, the disclosed fabrication steps enable fabricating bus waveguides and shunt waveguides having lower optical loss (e.g., insertion loss) in visible and/or near infrared wavelength ranges, compared to bus waveguides and shunt waveguides used in existing switching cells. In some examples, the disclosed switching cells can include bus waveguides and shunt waveguides comprising single crystal silicon (also referred to as monocrystalline silicon) and silicon nitride. In some embodiments, the optical propagation loss in the bus and shunt optical waveguides of the switching cells described below can be less than 1 dB/cm, less than 0.5 dB/cm, less than 0.1 dB/cm, less than 0.01 dB/cm, or smaller values for light having a wavelength within an operational wavelength range of the switching cell. In some cases, the operational wavelength range of the switching cell, can be from 400 nm to 1100 nm to 1200 nm, from 1200 nm to 1400 nm, 1400 nm to 1500 nm, from 1500 nm to 1600 nm, from 1260 to 1360 nm, from 1450 to 1650 nm or any ranges within ranges formed by these values or larger or smaller values.

In some embodiments, the bus waveguides are fabricated in as first layer and the shunt waveguide is fabricated as a second layer above the first layer using a sacrificial layer as a spacer. In some examples, the sacrificial layer may comprise an organic material so that it can be removed without affecting the structural properties (e.g., surface roughness) of the substrate, bus waveguides, and the shunt waveguide. Additionally, the disclosed fabrication methods may allow fabricating optical switches connected to the substrate by metallic clamping support structures (e.g., metallic pillars or vias).

FIGS. 10A-10B schematically illustrate two side cross-sectional views of the MEMS optical switch in FIG. 9A depicting the metallic control electrodes electrically connected to electrical feedthroughs formed within the substrate. FIG. 10A shows a vertical cross-section of a portion of the fabricated layered structure in the A-A′ cut plane parallel to x-y plane and away from the coupling regions. In some cases, the conductive clamping support structures 122 may comprise a hybrid structure comprising a metallic region (e.g., conductive pillars or vias) and a non-conductive (e.g., polymeric) region. In some cases, the non-conductive region of the conductive clamping support structures 122 may mechanically reinforce the conductive region).

In some embodiments, a cladding layer may be disposed on the first shunt waveguide 133-1, e.g., after the fabrication to adjust an effective refractive index of the first shunt waveguide 133-1 (e.g., the effective index of the widest portion of the first shunt waveguide 133-1). In some examples, the composition and the thickness of the cladding layer may be configured such that the effective refractive index of the first shunt waveguide 133-1 becomes closer to the refractive index of a bus waveguide to which the first shunt waveguide 133-1 is optically coupled, when the optical switch is in the ON state.

FIG. 10B illustrates a side cross-sectional view of the first shunt section 135-1, in a cut plane parallel to x-z plane, near one coupling end of the first shunt waveguide 133-1 when the optical switch is in the OFF state (solid lines corresponding to FIG. 10B) and the ON state (dashed line corresponding to FIG. 10B). As shown in FIG. 10B, the conductive clamping support structures 122 clamp a middle region of the first shunt section 135-1 and the flexible support structures 120 allow the first shunt waveguide 133-1 to move in the vertical direction (e.g., along x-axis) while providing an upward mechanical force (“Fmech”).

In some embodiments, the top electrode 124a may be electrically connected to a first conductive pad 62-1a formed on a bottom major surface of the base substrate 63 (e.g., a silicon base substrate 63 comprising an isolating silicon dioxide layer that is not shown) by the conductive clamping support structure 122 and a first through-substrate via 62-1b formed in the base substrate 63. In some cases, the clamping support structure 122 may comprise a multilayer conductive layer. In some cases, the top electrode 124a may be electrically connected to the first conductive pad 62-1a by a conductive structure different from the support structure 122. In some cases, the second top electrode 124b may be electrically connected to the top electrode 124a (e.g., via a conductive path within the base substrate 63). In some embodiments, the bottom electrode 106a may be electrically connected to a second conductive pad 61-1a formed on a bottom major surface of the base substrate 63 by a second through-substrate via 61-1b formed in the base substrate 63. In some cases, the second bottom electrode 106b may be electrically connected to the bottom electrode 106a (e.g., via a conductive path within the base substrate 63). In some embodiments, an electrical feedthrough may be electrically in contact with the top or bottom electrode 124a, 106a though a conductive layer (e.g., a conductive semiconductor layer such as doped silicon). This conductive layer can be different for each MEMS optical switch and conductive layers of different MEMS optical switches can be electrically isolated. In some examples, the plurality of the conductive pads 30 (in FIG. 1B) may comprise one or both the conductive pads 62-1a and 61-1a through which a potential difference may be generated between the top and bottom electrodes 124a, 106a of a MEMS optical switch to move the first shunt waveguide 133-1 toward the first bus optical waveguide 25-1. In some embodiments, the top or the bottom electrodes of individual MEMS optical switches may be electrically connected to each other and to one or more common electrical feedthroughs, e.g., via conductive paths formed within the MEMS substrate 66. In some such embodiments, the other one of the top and bottom electrodes of individual MEMS optical switches, each may be electrically connected to electrically isolated conductive pads (e.g., conductive pads 62), through electrically isolated electrical feedthroughs. In some examples, the one or more common conductive pads may be connected to an electrical ground and the electrically isolated conductive pads, each may be configured to receive an independent electric control signal configured to switch ON the respective MEMS optical switch by generating a potential difference between its top and bottom electrodes.

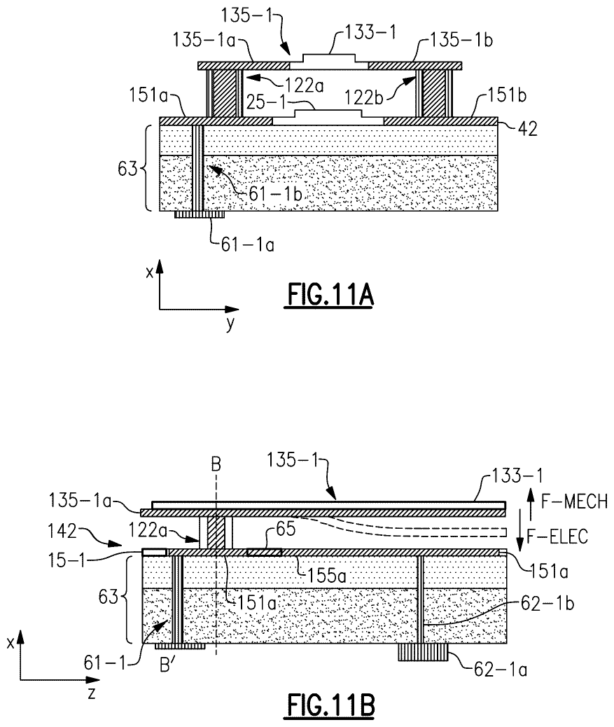

As described above, in some embodiments, conductive regions formed in shunt sections and the fixed waveguide layer 42 may serve as electrodes of a MEMS optical switch. In some embodiments, the top electrodes 124a, 124b and the bottom electrodes 106a, 106b, of the MEMS optical switch 50 may be replaced with electrode regions formed within the first shunt section 135-1 and the fixed waveguide layer 42. In some examples, these electrode regions may comprise highly doped regions of a semiconductor layer. FIGS. 11A-11B schematically illustrate two side cross-sectional views of another embodiment of the MEMS optical switch 50, comprising doped electrode regions electrically connected to electrical feedthroughs formed within the substrate.

FIG. 11A shows a vertical cross-section of a portion of the MEMS optical switch in the A-A′ cut plane parallel to x-y plane and away from the coupling region and FIG. 11B illustrates a side cross-sectional view of the MEMS optical switch, in a cut plane parallel to x-z plane, near one coupling end of the first shunt waveguide 133-1 when the optical switch is in the OFF state and the ON state. In some embodiments, the first shunt section 135-1 of the MEMS optical switch shown in FIG. 11A may comprise first and second shunt electrode regions 135-1a, 135-1b, formed on opposite lateral sides of the first shunt waveguide 133-1. In some embodiments, the first shunt electrode region 135-1a may be electrically connected by a first conductive region 151a formed on the fixed waveguide layer 42 and the second top electrode region 135-1b may be electrically connected by a second conductive region 151b formed on the fixed waveguide layer 42. In some cases, the first and second conductive regions 151a, 151b, may be electrically connected by a conductive bridge formed over the fixed waveguide layer 42.

In some embodiments, the fixed waveguide layer 42 of the MEMS optical switch shown in FIG. 11A may comprise first and second bottom electrode regions formed on opposite lateral sides of the first bus waveguide 25-1. The first bottom electrode region 155a is depicted in FIG. 11A. In some cases, the first bottom electrode region 155a may be electrically isolated from the second bottom electrode region (not shown) by an isolating region 65 (e.g., an isolating loop). In some embodiments, the first through-substrate via 62-1b may be electrically connected to the first bottom electrode region 151 and the first bottom electrode region 151 may be electrically connected to the second bottom electrode region 152 by a conductive bridge (not shown). In some embodiments, a first through-substrate via 62-1b may be electrically connected to the first conductive region 151a and thereby the first shunt electrode region 135-1a. In some embodiments, a second through-substrate via 61-1b may be electrically connected to the first bottom electrode region 155a.

In some embodiments, a MEMS optical switch of the integrated optical switch package 45 or 60 may comprise the MEMS optical switch shown in FIGS. 10A-10B or FIGS. 11A-11B.

### Example Embodiments

Additional embodiments, features, and variations of the disclosure are described in the following clauses:

Clause 1. An integrated optical circuit, comprising: a substrate having formed thereover a fixed waveguide layer comprising a first bus optical waveguide, a second bus optical waveguide and first bias electrode regions; a suspended waveguide layer formed over the fixed waveguide layer and comprising a first shunt optical waveguide and second bias electrode regions electrically isolated from the first bias electrode regions; and one or both of: a first through-substrate via (TSV) formed through the substrate to electrically connect to the first bias electrode regions, and a second TSV formed through the substrate to electrically connect to the second bias electrode regions, wherein upon application of a voltage across the first and second bias electrode regions, at least one end region of the first shunt waveguide mechanically bends toward the first bus optical waveguide or the second bus optical waveguide, thereby redirecting light from the first bus optical waveguide to the second bus optical waveguide.

Clause 2. The integrated optical circuit of Clause 1, wherein the integrated optical circuit comprises both of the first TSV and the second TSV.

Clause 3. The integrated optical circuit of Clause 2, wherein the suspended waveguide layer further comprises a second shunt optical waveguide and third bias electrode regions electrically isolated from the first bias electrode regions and electrically connected to a third TSV formed through the substrate, and wherein upon application of a voltage across the third TSV and fourth bias electrode regions of the fixed waveguide layer, at least one coupling region of the second shunt waveguide mechanically bends toward the first bus optical waveguide, thereby redirecting light from the first bus optical waveguide to another bus optical waveguide in the fixed waveguide layer.

Clause 4. The integrated optical circuit of Clause 3, wherein the first and second shunt optical waveguides are independently actuated in response to respective first and second voltages applied to the first and third TSVs, the first and second voltages being referenced to a reference voltage supplied to one or both second and fourth TSVs.

Clause 5. The integrated optical circuit of Clause 3, wherein the second and fourth bias electrode regions are electrically isolated by an insulating region formed within the fixed waveguide layer.

Clause 6. The integrated optical circuit of Clause 5, wherein the insulating region comprises an insulation loop laterally enclosing the first or second bias electrode regions.

Clause 7. The integrated optical circuit of Clause 5, wherein the fourth bias electrode region of the fixed waveguide substrate is electrically connected to a fourth TSV formed through the substrate or to the second TSV.

Clause 8. The integrated optical circuit of any one of Clauses 1-7, wherein the fixed waveguide layer comprises: first doped regions electrically connected to the first bias electrode regions; and second doped regions electrically isolated from the first doped regions and electrically connected to the second bias electrode regions.

Clause 9. The integrated optical circuit of Clause 8, wherein one of the first and second TSVs directly electrically connects to one of the first and second doped regions.

Clause 10. The integrated optical circuit of Clause 9, wherein the other of the first and second TSVs electrically connects to the other of the first and second doped regions through a vertical connector connecting the fixed waveguide layer and the suspended waveguide layer.

Clause 11. The integrated optical circuit of Clause 10, wherein the fixed waveguide layer comprises a thin film of silicon, and wherein the first and second doped regions are electrically isolated from each other by an insulating region comprising dielectric trenches extending vertically through the thin film of silicon.

Clause 12. The integrated optical circuit of any one of Clauses 1-11, wherein the at least one end region mechanically bends in response to an electrostatic force between the first and second bias electrode regions.

Clause 13. The integrated optical circuit of any one of Clauses 1-12, wherein the substrate comprises sidewalls surrounding the fixed waveguide layer and the suspended waveguide layer, and wherein the integrated optical circuit further comprises a capping substrate bonded to the sidewalls of the substrate to form a sealed cavity containing the first and second bus optical waveguides and the first shunt waveguide.

Clause 14. The integrated optical circuit of any one of Clauses 1-13, wherein the first and second TSVs vertically extend from the fixed waveguide layer respectively to first and second terminal ends exposed at a major surface of the substrate opposing the fixed waveguide layer.

Clause 15. The integrated optical circuit of Clause 14, wherein application of the voltage across the first and second bias electrode regions comprises applying first and second voltages respectively to the first and second terminal ends.

Clause 16. The integrated optical circuit of Clause 14, wherein the first and second terminal ends comprise first and second contact pads form at or on the major surface.

Clause 17. The integrated optical circuit of any one of Clauses 1-16, wherein the first shunt waveguide comprises first and second end regions and upon application of the voltage across the first and second bias electrodes, the first end region mechanically bends toward the first bus optical waveguide and the second end region mechanically bends toward the second bus optical waveguide.

Clause 18. The integrated optical circuit of Clause 17, wherein the first bias electrode regions comprise a first pair of conductive regions adjacent the first end region and a second pair of conductive regions adjacent the second end region, and wherein the first shunt waveguide separates different conductive regions of each the first and second pairs.

Clause 19. The integrated optical circuit of any one of Clauses 1-18, wherein the first bias electrode regions are electrically connected to the first TSV via at least one conductive post vertically extending between the fixed waveguide layer and the suspended waveguide layer.

Clause 20. The integrated optical circuit of Clause 19, wherein the at least one conductive post is configured to mechanically support the first shunt waveguide to establish a vertical separation between the first shunt waveguide and the fixed waveguide layer.

Clause 21. The integrated optical circuit of Clause 19, wherein the first bias electrode regions are electrically connected to the first TSV further through a first conductive region of the fixed waveguide layer.

Clause 22. The integrated optical circuit of Clause 19, wherein the second bias electrode regions are electrically connected to the second TSV through a second conductive region of the fixed waveguide layer.

Clause 23. The integrated optical circuit of Clause 22, wherein the first and second conductive regions are electrically isolated by an insulating region formed within the fixed waveguide layer.

Clause 24. The integrated optical circuit of Clause 23, wherein the insulating region comprises an insulation loop enclosing the first or second conductive regions.

Clause 25. The integrated optical circuit of Clause 22, wherein a doping level of the first and second bias electrode regions and the first and second conductive regions are at least ten times greater than that of the first optical bus and shunt waveguides.

Clause 26. The integrated optical circuit of any one of Clauses 1-25, wherein the first and second bias electrode regions comprise metallic electrodes formed on the fixed waveguide layer and the suspended waveguide layer.

Clause 27. The integrated optical circuit of any one of Clauses 1-26, wherein the first and second bias electrode regions comprise heavily doped regions of the fixed and suspended waveguide layers, respectively.

Clause 28. The integrated optical circuit of any one of Clauses 1-27, wherein the first bias electrode regions comprise two conductive regions of the shunt waveguide layer separated by the first shunt waveguide.

Clause 29. The integrated optical circuit of Clause 28, wherein the two conductive regions are electrically connected by a conductive bridge formed over the fixed substrate layer via a conductive region of the fixed substrate layer.

Clause 30. The integrated optical circuit of any one of Clauses 1-29, wherein two conductive regions of the fixed waveguide layer separated by the first bus waveguide or the second bus waveguide are electrically connected by a conductive bridge formed over the fixed substrate layer.

Clause 31. The integrated optical circuit of any one of Clauses 1-30, wherein a vertical projection of the first bias electrode regions on the fixed substrate at least partially overlaps with the second bias electrode regions.

Clause 32. The integrated optical circuit of any one of Clauses 1-31, further comprising an optical edge coupler configured to optically couple the first bus optical waveguide to an optical source or to an optical waveguide separate from the integrated optical circuit.

Clause 33. The integrated optical circuit of Clause 32, wherein the optical edge coupler terminates at a facet that is substantially perpendicular to a major surface of the substrate.

Clause 34. The integrated optical circuit of Clause 33, wherein the facet is an etched facet.

Clause 35. The integrated optical circuit of Clause 33, wherein the facet is a cleaved or diced facet.

Clause 36. An integrated optical circuit, comprising: a substrate; a fixed waveguide layer formed over the substrate and comprising: first doped regions and second doped regions electrically isolated from the second doped regions, and a first bus optical waveguide, a second bus optical waveguide and first bias electrode regions electrically connected to the first doped regions; and a suspended waveguide layer formed over the fixed waveguide layer and comprising a first shunt optical waveguide and second bias electrode regions electrically connected to the second doped regions, wherein upon application of a voltage across the first bias electrode regions and the second bias electrode regions through the first doped regions and the second doped regions, respectively, at least one region of the shunt waveguide mechanically bends toward the first bus optical waveguide or the second bus optical waveguide, thereby redirecting light from the first bus optical waveguide to the second bus optical waveguide.

Clause 37. The integrated optical circuit of Clause 36, further comprising: one or both of: a first through-substrate via (TSV) formed through the substrate to electrically connect to the first bias electrode regions; and a second TSV formed through the substrate to electrically connect to the second bias electrode regions.

Clause 38. The integrated optical circuit of Clause 37, wherein the optical circuit comprises both of the first TSV and the second TSV.

Clause 39. The integrated optical circuit of Clause 37, wherein one of the first and second TSVs directly electrically connects to one of the first and second doped regions.

Clause 40. The integrated optical circuit of Clause 38, wherein the other of the first and second TSVs electrically connects to the other of the first and second doped regions through a vertical connector connecting the fixed waveguide layer and the suspended waveguide layer.

Clause 41. The integrated optical circuit of Clause 36, wherein the first bias electrode regions comprise a first pair of conductive regions separated by one or both bus first and second optical waveguides and electrically connected by a first conductive bridge formed over the first or the second bus optical waveguides.

Clause 42. The integrated optical circuit of Clause 36, wherein the second bias electrode regions are electrically connected to the second doped regions by a vertical conductive connector extending between the suspended and fixed waveguide layers.

Clause 43. The integrated optical circuit of Clause 42, wherein the second bias electrode regions comprise a second pair of conductive regions separated by the first shunt waveguide and electrically connected by the vertical conductive connector and a second conductive bridge formed over the first or the second bus optical waveguides.

Clause 44. An integrated optical switch matrix comprising: a plurality of switching cells at crossings between first bus optical waveguides and second bus optical waveguides formed over a substrate, wherein each of the switching cells comprises a shunt optical waveguide having one or more regions configured to mechanically bend toward one or both of respective ones of the first bus optical waveguide and the second bus optical waveguide upon application of a voltage between first bias electrode regions and second bias electrode regions, thereby causing light from the respective one of the first bus optical waveguide to be redirected to the respective one of the second bus optical waveguide; and one or both of: a first through-substrate via (TSV) formed through the substrate to electrically connect to the first bias electrode regions, and a second TSV formed through the substrate to electrically connect to the second bias electrode regions.

Clause 45. An integrated optical switch matrix comprising: a plurality of switching cells at crossings between first bus optical waveguides and second bus optical waveguides formed over a substrate, wherein each of the switching cells comprises a shunt optical waveguide having one or more coupling regions configured to mechanically bend toward one or both of respective ones of the first bus optical waveguide and the second bus optical waveguide upon application of a voltage between first bias electrode regions and second bias electrode regions, thereby causing light from the respective one of the first bus optical waveguide to be redirected to the respective one of the second bus optical waveguide; and a waveguide layer formed over the substrate having formed therein one or both of the first and second bus optical waveguides, the waveguide layer comprising: first doped regions and second doped regions electrically isolated from the first doped regions, and first bias electrode regions electrically connected to the first doped regions.

Clause 46. An integrated optical circuit, comprising: a substrate having formed thereover a first bus optical waveguide and a second bus optical waveguide; a shunt optical waveguide having one or more regions configured to mechanically bend toward one or both of the first bus optical waveguide and the second bus optical waveguide upon application of a voltage between first bias electrode regions and second bias electrode regions, thereby causing light from the first bus optical waveguide to be redirected to the second bus optical waveguide; and one or both of: a first through-substrate via (TSV) formed through the substrate to electrically connect to the first bias electrode regions, and a second TSV formed through the substrate to electrically connect to the second bias electrode regions.

Clause 47. An integrated optical circuit, comprising: a substrate having formed thereover a first bus optical waveguide and a second bus optical waveguide; a shunt optical waveguide having one or more regions configured to mechanically bend toward one or both of the first bus optical waveguide and the second bus optical waveguide upon application of a voltage between first bias electrode regions and second bias electrode regions, thereby causing light from the first bus optical waveguide to be redirected to the second bus optical waveguide; and a waveguide layer formed over the substrate having formed therein one or both of the first and second bus optical waveguides, the waveguide layer comprising one or both of: first doped regions electrically connected to the first bias electrode regions, and second doped regions electrically isolated from the first doped regions and electrically connected to the second bias electrode regions.

Clause 48. A method of fabricating an integrated optical circuit die, the method comprising: providing a substrate having a first major surface and an opposing second major surface; forming a fixed waveguide layer over the first major surface of the substrate, the fixed waveguide layer comprising first and second bus optical waveguides, first bias electrode regions and at least one dielectric region electrically isolating the first bias electrode region from another conductive region of the fixed waveguide layer; forming a sacrificial layer and a conductive post over the first waveguide layer; forming a suspended waveguide layer over the sacrificial layer, the suspended waveguide layer comprising a first shunt section, the first shunt section comprising a first shunt optical waveguide and second bias electrode regions; removing a portion of the sacrificial layer to release the first shunt section and to form an opening over the substrate; forming a first conductive through substrate via (TSV) electrically connected to the first bias electrode regions, the first TSV vertically extending through the substrate and having a first terminal end exposed at the second major surface to form a first conductive contact pad; and forming a second TSV electrically connected to the second bias electrode regions via the conductive post and a conductive region of the fixed waveguide layer, the second TSV vertically extending through the substrate and having a second terminal end exposed at the second major surface to form a second conductive contact pad; wherein the first and second TSVs are electrically isolated by the at least one dielectric region.

Clause 49. The method of Clause 48, wherein upon application of a voltage across the first and second bias electrode regions through the first and second TSVs, at least one end region of the first shunt waveguide mechanically bends toward the first bus optical waveguide or the second bus optical waveguide, thereby redirecting light from the first bus optical waveguide to the second bus optical waveguide.

Clause 50. The method of any one of Clauses 48-49, wherein the first and second bias electrode regions and the conductive region of the fixed waveguide section comprise doped regions.

Clause 51. The method of any one of Clauses 48-50, wherein the first and second bias electrode regions comprise metallic regions.

Clause 52. The method of any one of Clauses 48-51, wherein the conductive post is configured to mechanically support the first shunt section.

Clause 53. The method of any one of Clauses 48-52, wherein the at least one dielectric region comprises a dielectric loop enclosing the first conductive region of the fixed waveguide layer.

Clause 54. The method of any one of Clauses 48-53, wherein forming first and second TSVs comprises reducing a thickness of the substrate and depositing a lower insulating layer on or over the second major surface.

Clause 55. The method of any one of Clauses 48-54, further comprising forming a conductive bridge over the substrate, the conductive bridge configured to electrically connect a pair of conductive regions of the second bias electrode regions are laterally separated by the first shunt waveguide.

Clause 56. The method of any one of Clauses 48-55, further comprising bonding a capping substrate to the substrate to cover the opening and to form a sealed cavity containing the first and second bus optical waveguides.

Clause 57. The method of Clause 56, further comprising forming an optical edge coupler configured to optically couple the first bus optical waveguide to an optical source or to an optical waveguide separate from the integrated optical circuit die.

Clause 58. The method of Clause 57, further comprising forming an optical facet wherein the optical edge coupler is terminated at the optical facet.

Clause 59. The method of Clause 58, wherein forming the optical facet comprises cutting or cleaving the substrate, the sacrificial layer, and the capping substrate.

Clause 60. The method of Clause 58, wherein forming the optical facet comprises: forming a first trench in the sacrificial layer and the substrate, wherein an internal vertical surface of the first trench comprises the optical facet; prior to bonding the capping substrate, forming a second trench in the capping substrate; and cutting or cleaving the substrate, the sacrificial layer, and the capping substrate along a surface normal to the first major surface and passing through the first and second trenches, wherein bonding a capping substrate to the substrate comprises aligning the first and second trenches.

### Additional Considerations

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

In the embodiments described above, apparatus, systems, and methods for sensing electrical overstress events are described in connection with particular embodiments. It will be understood, however, that the principles and advantages of the embodiments can be used for any other systems, apparatus, or methods with a need for sensing and/or protecting against electrical overstress events.

The principles and advantages described herein can be implemented in various apparatuses. Examples of such apparatuses can include, but are not limited to, consumer electronic products, parts of the consumer electronic products, electronic test equipment, etc. Examples of parts of consumer electronic products can include clocking circuits, analog to digital converts, amplifiers, rectifiers, programmable filters, attenuators, variable frequency circuits, etc. Examples of the electronic devices can also include memory chips, memory modules, circuits of optical networks or other communication networks, and disk driver circuits. Consumer electronic products can include, but are not limited to, wireless devices, a mobile phone (for example, a smart phone), cellular base stations, a telephone, a television, a computer monitor, a computer, a hand-held computer, a tablet computer, a laptop computer, a personal digital assistant (PDA), a microwave, a refrigerator, a stereo system, a cassette recorder or player, a DVD player, a CD player, a digital video recorder (DVR), a VCR, an MP3 player, a radio, a camcorder, a camera, a digital camera, a portable memory chip, a washer, a dryer, a washer/dryer, a copier, a facsimile machine, a scanner, a wrist watch, a smart watch, a clock, a wearable health monitoring device, etc. Further, apparatuses can include unfinished products.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected”, as generally used herein, refer to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a measurement error.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states.

The teachings of the inventions provided herein can be applied to other systems, not necessarily the systems described above. The elements and acts of the various embodiments described above can be combined to provide further embodiments. The acts of the methods discussed herein can be performed in any order as appropriate. Moreover, the acts of the methods discussed herein can be performed serially or in parallel, as appropriate.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. Accordingly, the scope of the present inventions is defined by reference to the claims.

1. An integrated optical circuit, comprising:
a substrate having formed thereover a fixed waveguide layer comprising a first bus optical waveguide, a second bus optical waveguide and first bias electrode regions;
a suspended waveguide layer formed over the fixed waveguide layer and comprising a first shunt optical waveguide and second bias electrode regions electrically isolated from the first bias electrode regions; and
one or both of:
a first through-substrate via (TSV) formed through the substrate to electrically connect to the first bias electrode regions, and
a second TSV formed through the substrate to electrically connect to the second bias electrode regions,
wherein upon application of a voltage across the first and second bias electrode regions, at least one end region of the first shunt waveguide mechanically bends toward the first bus optical waveguide or the second bus optical waveguide, thereby redirecting light from the first bus optical waveguide to the second bus optical waveguide.

2. The integrated optical circuit of claim 1, wherein the integrated optical circuit comprises both of the first TSV and the second TSV.

3. The integrated optical circuit of claim 2, wherein the suspended waveguide layer further comprises a second shunt optical waveguide and third bias electrode regions electrically isolated from the first bias electrode regions and electrically connected to a third TSV formed through the substrate, and wherein upon application of a voltage across the third TSV and fourth bias electrode regions of the fixed waveguide layer, at least one coupling region of the second shunt waveguide mechanically bends toward the first bus optical waveguide, thereby redirecting light from the first bus optical waveguide to another bus optical waveguide in the fixed waveguide layer.

4. The integrated optical circuit of claim 3, wherein the first and second shunt optical waveguides are independently actuated in response to respective first and second voltages applied to the first and third TSVs, the first and second voltages being referenced to a reference voltage supplied to one or both second and fourth TSVs.

5. The integrated optical circuit of claim 3, wherein the second and fourth bias electrode regions are electrically isolated by an insulating region formed within the fixed waveguide layer.

6. The integrated optical circuit of claim 5, wherein the insulating region comprises an insulation loop laterally enclosing the first or second bias electrode regions.

7. The integrated optical circuit of claim 5, wherein the fourth bias electrode region of the fixed waveguide substrate is electrically connected to a fourth TSV formed through the substrate or to the second TSV.

8. The integrated optical circuit of claim 1, wherein the fixed waveguide layer comprises:
first doped regions electrically connected to the first bias electrode regions; and
second doped regions electrically isolated from the first doped regions and electrically connected to the second bias electrode regions.

9. The integrated optical circuit of claim 8, wherein one of the first and second TSVs directly electrically connects to one of the first and second doped regions.

10. The integrated optical circuit of claim 9, wherein the other of the first and second TSVs electrically connects to the other of the first and second doped regions through a vertical connector connecting the fixed waveguide layer and the suspended waveguide layer.

11. The integrated optical circuit of claim 10, wherein the fixed waveguide layer comprises a thin film of silicon, and wherein the first and second doped regions are electrically isolated from each other by an insulating region comprising dielectric trenches extending vertically through the thin film of silicon.

12. The integrated optical circuit of claim 1, wherein the at least one end region mechanically bends in response to an electrostatic force between the first and second bias electrode regions.

13. The integrated optical circuit of claim 1, wherein the substrate comprises sidewalls surrounding the fixed waveguide layer and the suspended waveguide layer, and wherein the integrated optical circuit further comprises a capping substrate bonded to the sidewalls of the substrate to form a sealed cavity containing the first and second bus optical waveguides and the first shunt waveguide.

14. The integrated optical circuit of claim 1, wherein the first and second TSVs vertically extend from the fixed waveguide layer respectively to first and second terminal ends exposed at a major surface of the substrate opposing the fixed waveguide layer.

15. The integrated optical circuit of claim 14, wherein application of the voltage across the first and second bias electrode regions comprises applying first and second voltages respectively to the first and second terminal ends.

16. The integrated optical circuit of claim 14, wherein the first and second terminal ends comprise first and second contact pads form at or on the major surface.

17. The integrated optical circuit of claim 1, wherein the first shunt waveguide comprises first and second end regions and upon application of the voltage across the first and second bias electrodes, the first end region mechanically bends toward the first bus optical waveguide and the second end region mechanically bends toward the second bus optical waveguide.

18. The integrated optical circuit of claim 17, wherein the first bias electrode regions comprise a first pair of conductive regions adjacent the first end region and a second pair of conductive regions adjacent the second end region, and wherein the first shunt waveguide separates different conductive regions of each the first and second pairs.

19. The integrated optical circuit of claim 1, wherein the first bias electrode regions are electrically connected to the first TSV via at least one conductive post vertically extending between the fixed waveguide layer and the suspended waveguide layer.

20. The integrated optical circuit of claim 19, wherein the at least one conductive post is configured to mechanically support the first shunt waveguide to establish a vertical separation between the first shunt waveguide and the fixed waveguide layer.

21. The integrated optical circuit of claim 19, wherein the first bias electrode regions are electrically connected to the first TSV further through a first conductive region of the fixed waveguide layer.

22. The integrated optical circuit of claim 19, wherein the second bias electrode regions are electrically connected to the second TSV through a second conductive region of the fixed waveguide layer.

23. The integrated optical circuit of claim 22, wherein the first and second conductive regions are electrically isolated by an insulating region formed within the fixed waveguide layer.

24. The integrated optical circuit of claim 23, wherein the insulating region comprises an insulation loop enclosing the first or second conductive regions.

25. The integrated optical circuit of claim 22, wherein a doping level of the first and second bias electrode regions and the first and second conductive regions are at least ten times greater than that of the first optical bus and shunt waveguides.

26. The integrated optical circuit of claim 1, wherein the first and second bias electrode regions comprise metallic electrodes formed on the fixed waveguide layer and the suspended waveguide layer.

27. The integrated optical circuit of claim 1, wherein the first and second bias electrode regions comprise heavily doped regions of the fixed and suspended waveguide layers, respectively.

28. The integrated optical circuit of claim 1, wherein the first bias electrode regions comprise two conductive regions of the shunt waveguide layer separated by the first shunt waveguide.

29. The integrated optical circuit of claim 28, wherein the two conductive regions are electrically connected by a conductive bridge formed over the fixed substrate layer via a conductive region of the fixed substrate layer.

30. The integrated optical circuit of claim 1, wherein two conductive regions of the fixed waveguide layer separated by the first bus waveguide or the second bus waveguide are electrically connected by a conductive bridge formed over the fixed substrate layer.

31. The integrated optical circuit of claim 1, wherein a vertical projection of the first bias electrode regions on the fixed substrate at least partially overlaps with the second bias electrode regions.

32. The integrated optical circuit of claim 1, further comprising an optical edge coupler configured to optically couple the first bus optical waveguide to an optical source or to an optical waveguide separate from the integrated optical circuit.

33. The integrated optical circuit of claim 32, wherein the optical edge coupler terminates at a facet that is substantially perpendicular to a major surface of the substrate.

34. The integrated optical circuit of claim 33, wherein the facet is an etched facet.

35. The integrated optical circuit of claim 33, wherein the facet is a cleaved or diced facet.

36.-60 (canceled)
